(19) United States
(12) Patent Application Publication
(10) Pub. No.: US 2025/0253632 A1
(43) Pub. Date: Aug. 7, 2025

(54) EXTERIOR JUNCTION BOXES

(71) Applicant: Easy Solar Products, Inc., Sandy, UT (US)

(72) Inventors: Alexander "Alec" Bornemann, Duxbury, VT (US); Ben Kadmon, Sandy, UT (US); Benjamin Wade, Holladay, UT (US); Brady Hoddinott, New Hartford, CT (US)

(73) Assignee: Easy Solar Products, Inc., Sandy, UT (US)

(21) Appl. No.: 19/044,234

(22) Filed: Feb. 3, 2025

Related U.S. Application Data
(60) Provisional application No. 63/627,984, filed on Feb. 1, 2024.
(60) Provisional application No. 63/550,735, filed on Feb. 7, 2024.
(60) Provisional application No. 63/571,386, filed on Mar. 28, 2024.
(60) Provisional application No. 63/688,815, filed on Aug. 29, 2024.

(51) Int. Cl. H02G 3/08; H02G 3/14

(52) U.S. Cl. CPC H02G 3/081; H02G 3/088; H02G 3/14

(57) ABSTRACT

Junction boxes suitable for mounting on exterior surfaces of buildings or other structures are injection molded or otherwise formed to include a housing and lid that are rigidly held together to protect wiring, fluid or other connections within an interior region of the box. The housing and lid may be held together using integrally-formed retention structures. Additional features can provide resistance to water or debris, as well as improved installation and retention of the box relative to the mounting surface. Junction boxes may also include an integrally-formed flashing for mounting on shingle or tile roofs, or similar structures.

### PRIORITY CLAIM

This application claims priority to the following United States Provisional Applications: Ser. No. 63/627,984 filed Feb. 1, 2024; Ser. No. 63/550,735 filed Feb. 7, 2024; Ser. No. 63/571,386 filed on Mar. 28, 2024; and Ser. No. 63/688,815 filed on Aug. 29, 2024. Each of these applications is incorporated herein by reference in its entirety.

### TECHNICAL FIELD

The following generally relates to junction boxes, such as those used to house electrical connections for solar energy systems. More particularly, the following relates to junction boxes that can be mounted on exterior surfaces such as walls or roofs of buildings to facilitate connections for solar energy systems or the like.

### BACKGROUND

The solar industry has experienced remarkable growth over the past decade or so, with widespread adoption of solar energy across a broad spectrum of residential, commercial, and industrial settings. This surge can be attributed to global awareness of renewable energy sources and the impacts of fossil fuel consumption, as well as to technological advancements that have made solar power more efficient and affordable. As a result, solar panels have become a common sight on buildings and in power generation facilities worldwide.

Often, solar panels are mounted on roofs, walls and/or other exterior surfaces of buildings to maximize sunlight exposure and to make efficient use of available space. In contrast to ground-mounted systems, roof-mounted installations can be less complex, easier to install, more aesthetically pleasing, more resistant to theft or vandalism, and can take up less space that would otherwise be available for other purposes. In many areas, homes and other buildings with rooftop mounted solar installations often enjoy increased property valuations due to the prospect of reduced energy costs.

One type of junction box suitable for use with several types of roofs is described in U.S. Pat. No. 11,695,261, which is incorporated herein by reference. Integrating solar panels onto certain mounting surfaces (e.g., composite shingle roofs, walls and/or the like), however, can present specific challenges that are not encountered with other environments. Traditional junction box designs, in particular, often fall short when applied to comp shingle roofing systems and other uneven surfaces due to issues related to installation complexity, electrical grounding, thermal expansion, potential for corrosion and the like. These challenges can be compounded by the different types of roofs currently available.

There is, therefore, a need for a junction box specifically designed for roofs, walls and other mounting surfaces that overcomes the limitations of current technologies. Ideally, such a design would offer a convenient installation process, facilitate installation on different types of structures, accommodate the thermal expansion characteristics of roofs and other surfaces, and enhance the overall aesthetic integration of solar panels with various mounting surfaces and locations. These and other features are described in increasing detail below.

### BRIEF DESCRIPTION

In response to these challenges, the following discussion introduces a junction box design that is tailored for mounting on external surfaces such as walls, roofs and the like. These junction boxes aim to simplify installation, ensure long-term durability and reliability under diverse environmental conditions, and improve the visual integration of solar panels with certain types of building materials, such as tile or composite shingle roofs. The new junction box design represents a significant advancement over current technologies by specifically addressing the unique requirements of tiles, shingles and/or other mounting surfaces commonly found on homes and other structures.

In one example, a junction box for attaching to a mounting surface suitably comprises a housing and a lid. The housing is formed of molded composite material and has a planar surface and a wall structure extending substantially perpendicularly from the planar surface away from the mounting surface to enclose an interior region of the junction box, wherein the housing further comprises a first joining member integrally formed with the wall structure of the housing. The lid is formed of the molded composite material, wherein the lid is shaped and sized to mate with the wall structure of the housing, the lid comprising an integrally-formed second joining member configured to interface with the first joining member of the housing to thereby maintain the housing and lid in rigid proximity to each other and thereby fully enclose the interior region of the junction box.

In another example, a junction box for attaching to a shingle, tile or other mounting surface suitably includes a housing, a lid and a flashing. The housing is formed of molded composite material and having a planar surface and a wall structure extending substantially perpendicularly from the planar surface away from the mounting surface. The lid is also formed of the molded composite material such that the lid is shaped and sized to mate with the wall structure of the housing to enclose an interior region of the junction box. The flashing may be integrally formed with the housing, and may comprise at least one ridge molded into the flashing that is oriented away from a center of the junction box to thereby divert water flowing toward the junction box toward an edge of the flashing.

Junction boxes may incorporate any number of enhanced features across a wide array of alternate embodiments. Some features described herein include, without limitation: features to improve water resistance, features to improve closure of the box, features to improve wire management within the box, features to ease installation, and the like. Each of these features may be inter-combined with each other in any manner, including any sub-sets of two or more features, if desired. Alternatively, each feature could be implemented independently even if the other features are not present in any particular embodiment.

To that end, any of the junction boxes described herein may be formed wherein the housing comprises a tab integrally molded with an exterior surface of the wall structure and wherein the lid comprises a loop structure integrally molded to project from an outer surface of the lid, wherein the loop structure is configured to receive the tab of the wall structure and thereby maintain the housing and lid in rigid proximity to each other.

Any of the junction boxes described herein could further comprise one or more wire management posts integrally molded with the housing, wherein the one or more wire management posts project upward from the planar surface of the housing into the interior region of the junction box.

Any of the junction boxes described herein could further comprise at least one boss integrally molded in the planar surface of the housing to guide placement of a fastener connecting the junction box to the mounting surface, wherein at least one boss not extend completely though the planar surface to form a hole therein.

Any of the junction boxes described herein could further comprise at least one boss that comprises first and second sets of teeth for receiving threads of the fastener, wherein the first set of teeth is oriented to above the second set of the teeth in a recessed area of the boss, and wherein the first and second sets of teeth are oriented orthogonally from each other within the recessed area of the boss.

Any of the junction boxes described herein could further comprise one or more clips integrally molded into a sidewall of the housing and one or more hook structures integrally molded in the planar surface of the housing, wherein the one or more clips and the one or more hook structures are configured to retain a DIN bar in place within the interior region of the junction box.

Any of the junction boxes described herein could further comprise a flashing that comprises one or more raised ridges angled to divert water away from the housing. In a further example, at least one of the one or more raised ridges is tapered toward a center of the junction box. Still further, one or more raised ridges may be set back from an upslope edge of the flashing to thereby permit at least a portion of the flashing upslope from the one or more raised ridges to be slid beneath a portion of the mounting surface.

Any of the junction boxes described herein could further comprise first and second integrally-formed lines in the planar surface, wherein the first integrally-formed line indicates a first drill zone for use during micro-flashed installations of the junction box, and wherein the second integrally-formed line indicates a second drill zone that is larger than the first drill zone for use during fully-flashed installations of the junction box. Some embodiments could further comprise a plurality of bosses integrally formed in the planar surface, wherein each of the plurality of bosses is configured to receive a fastener that passes through the planar surface into the mounting surface, but wherein each of the plurality of bosses extends only partially through the planar surface to thereby permit use of a first plurality of bosses during the micro-flashed installation and a second plurality of bosses different from the first plurality during fully-flashed installation.

Any of the junction boxes described herein could further form the planar surface of the junction box with one or more bosses each configured to receive a fastener for attaching the junction box to the mounting surface, and wherein the planar surface is formed with a compression ring interconnecting the one or more bosses to thereby apply additional compressive force against the mounting surface when the faster is tightened into the mounting surface. The compression ring could be located on the planar surface in a position that corresponds to a guide on an opposite side of the planar surface that indicates a position to apply an adhesive for further connecting the junction box to the mounting surface.

Any of the junction boxes described herein could further comprise a lid that is integrally formed with one or more protrusions on an inner surface of the lid, wherein the protrusions are configured to interface with the wall structure of the housing and thereby bias the lid into an open position until closing pressure is applied to the lid. The lid could comprises a vertical portion and a horizontal portion overlying the housing, and the protrusions could be formed as ridges at an intersection of the vertical and horizontal portions of the lid to thereby affect an angle between the vertical and horizontal portions. Additionally or alternatively, the one or more protrusions could comprise a spring member that applies a force against the housing that is overcome through tightening of a fastener that joins the lid to the housing.

Still other embodiments could comprise one or more weep holes formed in the wall structure extending above the planar surface to thereby drain moisture from the interior region of the junction box.

In still other embodiments, the flashing further comprises a side ridge proximate an exterior side of the housing, wherein the side ridge is a raised portion of the flashing configured to divert water flowing toward the junction box.

Again, the various features described herein may be combined in any manner to produce a wide array of alternate but equivalent embodiments. Alternatively, each feature could be implemented independently even if the other features are not present in any particular embodiment.

Additional embodiments provide other junction box systems, devices, and/or processes substantially as described herein, and/or their legal equivalents.

### DESCRIPTION OF THE DRAWING FIGURES

The following discussion is provided with reference to various drawing figures. The drawing figures referenced below illustrate various views of example embodiments of one or more junction boxes for consistency, although other embodiments will vary from the specific embodiments illustrated here.

FIG. 1A illustrates a perspective view of an example junction box with side retaining tabs for a lid;

FIG. 1B illustrates an exploded perspective view of the example junction box of FIG. 1A;

FIG. 1C illustrates an east side view of the example junction box of FIG. 1A;

FIG. 1D illustrates a west side view of the example junction box of FIG. 1A;

FIG. 2 illustrates a perspective view of the example junction box of FIG. 1A with an attached conduit;

FIG. 3A is a top view of an example junction box with a micro-flashing drill zone and a full flashing drill zone;

FIG. 3B is a bottom view of the example junction box of FIG. 3A;

FIG. 3C is a perspective view of the example junction box of FIG. 3A on a roof prior to micro-flashed installation;

FIG. 3D is a perspective view of the example junction box of FIG. 3A on a roof with a micro-flashed installation;

FIG. 3E is a perspective view of the example junction box of FIG. 3A prior to a fully flashed installation;

FIG. 3F is a perspective view of the example junction box of FIG. 3A with a fully flashed installation;

FIG. 4A is a perspective view of an example junction box with an overhang with a side snap lid attachment;

FIG. 4B is a perspective view of the example junction box of FIG. 4A with the lid removed;

FIG. 5A is a top perspective view of an example junction box without an overhang with a side snap lid attachment;

FIG. 5B is a top perspective view of the example junction box of FIG. 5A with the lid removed;

FIG. 5C is a bottom perspective view of the j example unction box of FIG. 5A;

FIG. 5D is a top view of the example junction box of FIG. 5A with the lid removed;

FIG. 5E is a bottom view and a side view of the example junction box of FIG. 5A;

FIG. 5F is a side view of the example junction box of FIG. 5A with the lid detached and with the lid connected;

FIG. 5G is a perspective view of the example junction box of FIG. 5A with the lid detached and with the lid connected;

FIG. 6 is a perspective view of the example junction box of FIG. 5A with a DIN rail detached, an end of the DIN rail under clips, and with the DIN rail installed;

FIG. 7 is a perspective view of an example junction box for a fully flashed installation with water-diverting ribs on a flashing and a hinged lid;

FIG. 8 is a side perspective view of the example junction box for a micro flashed installation with water-diverting ribs on a portion of the flashing and a rear-hinged lid.

FIG. 9A is a side perspective view of an example junction box for a fully flashed installation with water-diverting ribs on a portion of the flashing, side tabs to secure a lid and nubs on an end of a lid to snap the lid into place.

FIG. 9B is a side perspective view of the example junction box of FIG. 9A with the lid partially opened.

FIG. 9C is a perspective view of an under side of the lid of the example junction box of FIG. 9A depicting the nubs.

FIG. 9D is an east side view of the example junction box of FIG. 9A with the lid in place and depicting the nubs and side hooks holding the lid in place and a detail view of the nub.

FIG. 10A is a side perspective view of an example junction box with water-diverting ribs on a flashing along with side hooks and a rear hook to secure a lid.

FIG. 10B is another side perspective view of the example junction box of FIG. 12A with the lid partially open.

FIG. 11A is a side perspective view of an example junction box with a rotatable lid.

FIG. 11B is another side perspective view of the example junction box of FIG. 10A with the lid rotated and an edge in a notch to hold the lid.

FIG. 12A is a side cross section view of an example junction box having a boss with captive screw teeth as a fastener is started.

FIG. 12B is an enlarged side cross section view of the example junction box of FIG. 12A with the fastener being partially inserted in an angled manner.

FIG. 12C is an enlarged side cross section view of an example junction box similar to the junction box of FIG. 12A but with a same captive fastener being further advanced in the angled manner.

FIG. 13A is a side cross section view of an example junction box with a boss with self-aligning captive screw teeth prior to a fastener being inserted.

FIG. 13B is a side cross section view of the example junction box of FIG. 13A with a boss having self-aligning captive screw teeth.

FIG. 13C is an end cross section view of the example junction box of FIG. 13A in a direction orthogonal to that of FIG. 13B.

FIG. 13D is an enlarged cross section view of FIG. 13B depicting the fastener and the boss.

FIG. 13E is an enlarged cross section view of FIG. 13C depicting the fastener and the boss. and

FIG. 14 is a side cross section view of an example junction box with a boss having spiraled self-aligning captive screw teeth prior to a fastener being inserted.

FIG. 15A illustrates an example of a junction box having a spring member that biases the lid of the box into an open position until compressive force is applied.

FIG. 15B illustrates one technique for implementing a spring member that biases the lid of the box into an open position until compressive force is applied.

FIG. 15C illustrates another example of junction box with a spring member to bias the lid of the box into an open position until compressive force is applied.

FIG. 15D illustrates another example of a spring member that biases the lid of the box into an open position until compressive force is applied.

The various drawing figures provide alternate views of example junction box designs, with reference signs being consistent throughout the various drawings.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, a junction box is uniquely tailored for use with exterior mounting surfaces such as those commonly found on homes and other building structures. The general concepts described herein could be useful in mounting the junction box to several different types of roofs, including roofs made of tiles, composite or wood shingles, and/or other types of roofing materials as desired. The concepts may also be applied to other mounting locations, such as vertical walls and the like. Equivalent embodiments could use similar structures and concepts to provide a junction box that could be mounted to walls, siding, support columns, facias and/or other mounting surfaces, including any surfaces that are uneven. Further, the concepts set forth herein may be used to create a junction box that could be mounted to any relatively flat surfaces formed of any material, including metal, tile, wood, composite, other synthetic materials and/or the like. Equivalent designs could be used on self-flashing or flash-less roofs (e.g., roofs made from or coated with polyurethane or elastomeric materials such as silicone, urethane, acrylic and/or the like), for example, as well as composite shingle or tile roofs, to provide just a few examples. Similarly, equivalent concepts to those described herein could be used in junction boxes associated with other applications such as fluid flow (e.g., misting, irrigation or fire abatement systems), television or radio communications (e.g., satellite or terrestrial antenna connections) and/or the other applications as desired.

Various embodiments relate to junction boxes that are injection molded from composite material such as fiberglass reinforced polyester (FRP), glass reinforced plastic (GRP), carbon fiber reinforced polymer (CFRP), polycarbonate (PC) composites, glass-filled nylon, thermoset polyester composites, dough molding compound (DMC), bulk molding compound (BMC) and/or the like. Other materials (including materials that are subsequently derived from the materials listed or otherwise subsequently developed could also be used.

In the past, junction boxes made from polymer or other composite material were generally disregarded in favor of metal boxes due to a perceived lack of durability, weather resistance and the like. Boxes that are injection molded or otherwise formed from modern materials, however, can exhibit even better performance and durability characteristics than metal boxes. Moreover, the injection molding process allows for additional features to be added to the boxes, and for great variability in customizing different boxes for particular implementations or settings. Injection molding allows for incorporation of new features for assembly and installation, resistance to moisture or other contaminants, and/or improved performance. To that end, a number of improvements that can be integrally molded or otherwise formed in an electrical junction box are described herein. These features may be mixed and matched into a wide variety of different implementations, as desired.

In the discussion herein, the cardinal directions (i.e., “north”, “south”, “east”, “west”) are occasionally used to describe relative spatial positions of the junction box and/or its components. As will be apparent from context, these directions as used herein will not necessarily refer to compass directions in the traditional sense, but rather to orientation of the junction box relative to a peak, apex or higher point of a sloped roof. That is, the “north” end of the box as described herein is typically oriented towards up-slope toward the apex of the roof and the “south” end of the box is typically the opposite end of the box facing down-slope, opposite the apex of the roof. “East” and “west” can therefore refer to the right and left sides of the box, respectively, when the box is viewed from above. Again, this convention is used to describe orientation relative to the roof, and will become clear in context. Practical embodiments may use other reference frames as appropriate.

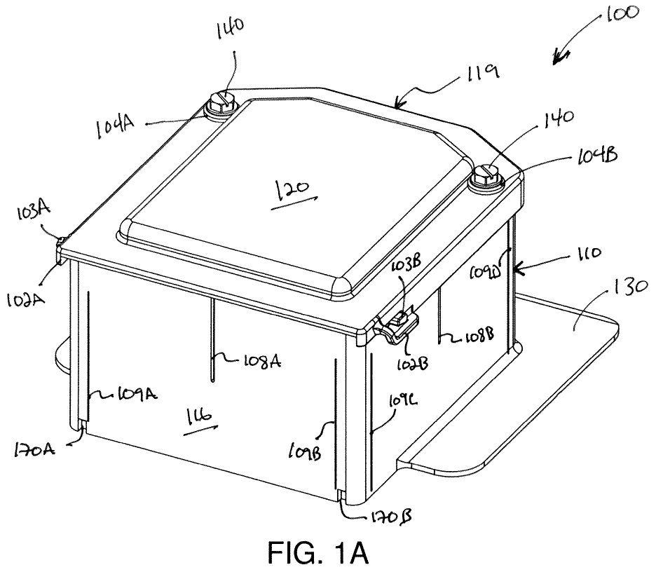

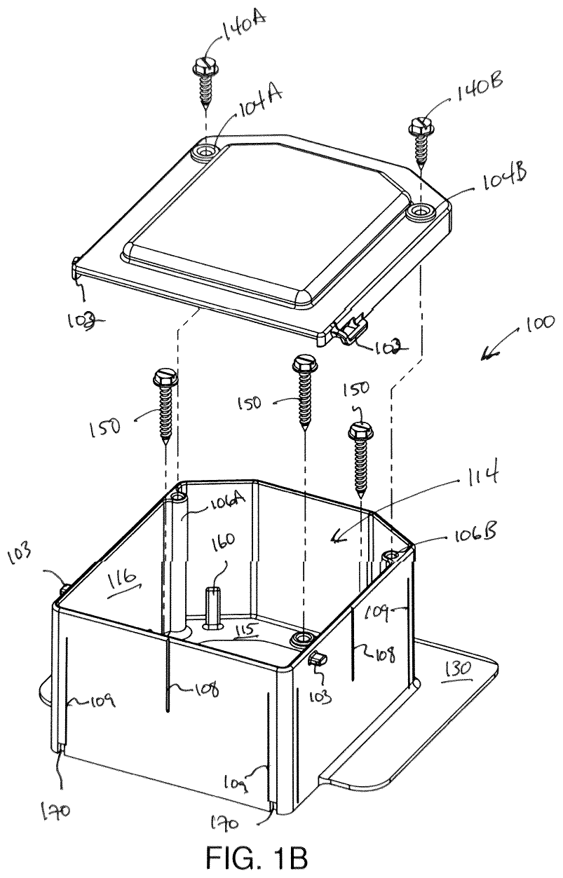

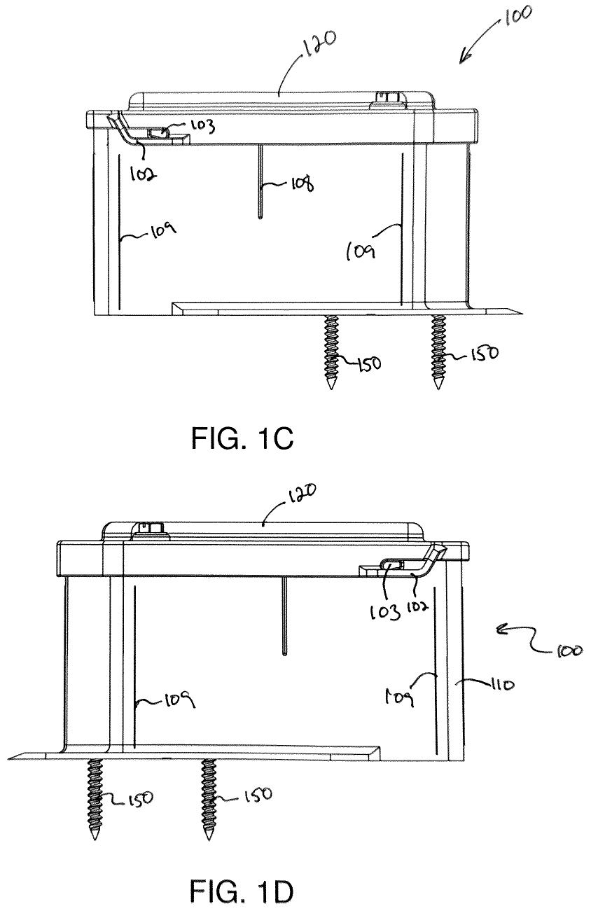

With reference now to FIG. 1A, an example junction box 100 suitably includes a housing 110 and a lid 120 that is sized and shaped to enclose an internal region 114 (not visible in FIG. 1A) of the junction box 100 to protect electrical connections residing within the internal region 114. The example box 100 illustrated in FIG. 1A also includes a flashing 130 for mounting to a shingle, tile or similar roof, although flashing 130 may not be present in other embodiments, particularly those intended for mounting in other locations or on other surfaces.

In various embodiments, housing 110, lid 120 and/or flashing 130 may be injection molded or otherwise formed from electrically-insulative plastic (e.g., polyvinyl chloride or the like), carbon fiber and/or any other material that is generally electrically insulative to prevent grounding problems, shorts or other electrical issues from occurring. Other embodiments could implement housing 110, lid 120 and/or flashing 130 from other materials, as desired. Injection molding or the like can permit various beneficial features to be integrally formed within the junction box 100. Hinges, latches, springs and/or other joining members can be formed to produce efficient and effective coupling of the lid 120 to the housing 110, for example. Similarly, drill guides, bosses, weep holes, hinges and/or other features can be molded or otherwise integrally formed with the box 100 itself, thereby aiding in installation and improving the usefulness of the junction box 100.

Beginning with the example of FIGS. 1A-D, housing 110 is molded or otherwise formed to include a planar surface 115 acting as a floor to the box, as well as one or more walls 116 extending approximately perpendicularly from the planar surface 115 to form an internal compartment 114 within the junction box 110. Planar surface 115 is appropriately designed to conform to the outer surface of the roof, wall or other mounting surface, and is appropriately sized to contain wire junctions, fluid junctions and/or other components within the internal compartment 114 of the housing 110. If a flashing 130 is present in a particular embodiment, the flashing 130 may be integrally molded or otherwise formed as part of housing 110, if desired. Other embodiments could provide flashing 130 as a separate feature that is joined to the housing 110 via screws, bolts or other connectors, or via an adhesive, and/or in any other manner.

In some embodiments, housing 110 includes one or more integrally-formed tabs 103A-B for use in joining lid 120 to housing 110. In the illustrated example, tabs 103A-B are shown on either side of housing 110 near a top of sidewall 116 to accommodate attachment to lid 120. Lid 120, conversely, is suitably formed to include a hook, loop or similar receiving member 102A-B that is capable of receiving one of the tabs 103A-B (respectively) to thereby maintain the lid 120 against the housing 110. In FIGS. 1A-D, the receiving members 102A-B are provided on opposite sides of lid 120 corresponding to tabs 103A-B (respectively) so that the receiving members 102A-B are able to mate with tabs 103A-B and retain tabs 103A-B within the retaining member 102A-B and thereby retain the lid 120 in a closed position against housing 110. The other end of box 100 may then be secured with one or more screws or similar fasteners 140, as appropriate.

In some embodiments, lid 120 is connected to housing 110 by sliding lid 120 transversely with respect to the top housing 110 until tabs 103 are properly seated within the loop or other retaining structure 102. In the example of FIG. 1, loop structure 102 is formed to include a longitudinal opening that accepts the tab 103 during the sliding motion, and then rigid member that holds the tab 130 in place after the tab 103 is slid though the longitudinal opening, thereby maintaining lid 120 to be flat and rigidly in place top of on housing 110. In FIGS. 1A-D, retaining members 102 each include a protective loop (best seen in FIGS. 1C-D) so that tabs 103 fit into the openings of the loop 120. Lid 120 is then secured by sliding the lid 120 so that the tab 103 engages with an extension portion of the loop 102. In such embodiments, the tabs 103 may include a depression on an underside of the tabs 103 and the extension portion of the loops 102 may include a bump that engages the depression on the underside of the tabs. In further embodiments, the lid 120 may have the loops 102 placed over the tabs 103 and lid 120 may be rotated so that the extension portions of loops 111 rotate under the tabs 103 such that a combination of rotating and sliding may secure the lid to the junction box.

If desired, lid 120 may be held even more securely by providing an additional attachment mechanism(s), such as one or more screws, bolts and/or other fasteners 104A-B on another part of the lid 120. That is, the tab/retaining member structures can be used to hold the lid 120 in place, with additional fasteners 104 providing additional security and compressive force against the housing 110. FIG. 1B shows retaining posts 106A-B formed on the interior 114 of housing 110 to receive threaded screws 140A-B through holes or bosses 104A-B (respectively) in lid 120. Other embodiments could provide additional fasteners 140, or a single fastener 140, or even no fasteners 140 if the tab/retaining structures 102/103 are augmented to provide sufficient compressive force between the lid 120 and housing 110. The use of one or more fasteners 104, however, can facilitate easier removal of lid 120 at a later date. Removing fasteners 104 could permit lid 120 to be rotated downward with the tabs 103 and retaining members 102 acting as a pivot point, for example, as described more fully in embodiments below. Generally speaking, it may be desirable to have about 3-4 points of contact to secure lid 120 to housing 110, although different embodiments will any combination of structures to achieve such contact, such as fasteners 140, tab/loop structures 103/102, hinges (see below) and/or the like.

The examples illustrated in FIGS. 1A-D show the tabs 103 near the south end (down slope portion) of housing 110, with the north end (up-slope) of the lid being secured by fasteners 140. In other embodiments, however, tabs 103 could be relocated to any other position along the upper side of the sidewalls 116 to receive retention members 102 of lid 120. Equivalently, the positions of tabs 103 and extensions 102 could be switched so that tabs 103 are molded or otherwise integrally formed to protrude from lid 120 and the loops/extensions 102 are integrally formed on the sidewalls 116 of the housing 110. In some embodiments, each side tab 103 may include a divot on an underside facing away from an opening for the lid 120. In this example, hooks or other retaining members 102 may each include a protrusion that mates within a divot of a tab 103 to thereby help snap the lid into place, and/or to maintain the lid 120 in a favorable position for placing and/or tightening fasteners 140. Additional details are provided with respect to other embodiments below.

Generally speaking, it is desirable to avoid (or at least reduce) build-up of water or other fluids within the internal 114 of housing 110. Several structures are described below that can aid in preventing water or debris from entering the box 100. In the event that water does enter the interior 114 of box 100 or if condensation should form inside the box 100, it can be helpful to provide an exit so that the water can be removed from the box 100. To that end, one or more weep holes 170A-B may be formed in the sidewalls 160 of housing 110 to permit fluids to drain out of the box. Generally, weep holes 170 will be formed on the downslope (“southerly”) sidewall of the box, which is where fluids would otherwise build up due to gravity. Other embodiments (particularly those intended for mounting on flat surfaces) may include additional or different weep holes 170 in any locations desired. In the absence of drainage features such as weep holes 170, water could build up and freeze, thereby leading to ice formation that could put pressure on structures within the interior 140 of box 100, or that could create ice dams or other issues. Placing the weep holes 170 in the sidewall 116 of the box 100 can allow for more effective drainage than weep holes placed in the floor 115, and can accommodate different mounting angles to account for different roof pitches or the like. Some embodiments could include weep holes 170 in both the floor 115 and sidewalls 116, if desired. Still other embodiments could provide a slot or similar feature that spans both a portion of the floor 115 and sidewall 116, if desired. Weep holes 170 and similar features could be implemented on any of the various junction boxes 100 described herein, although other embodiments could omit holes 170 or place the holes 170 in other locations, as desired.

In some implementations, weep holes 170 can be formed during injection molding by placing an insert into the mold to prevent material from flowing into the areas of the mold where holes 170 are desired. Alternatively, the holes could be removed by milling or drilling after the box 100 is molded, or the mold itself could be modified to create a tab or protrusion where the hole would otherwise form. Often, however, coolant lines or the like in the molding tool can limit the amount of material that can be removed when making the mold, thereby making the formation of holes during traditional molding to be somewhat challenging. Producing a mold tool that may not include the weep hole 170 and then placing an insert into the tool prior to molding, however, can have the effect of easily producing weep holes 170 into housing 110 at the desired location, while preserving the option to create housings 110 without the weep holes 170, if desired.

FIG. 1B illustrates several additional features that could be integrally molded or otherwise formed in the interior portion 114 of housing 110. One or more wire management posts 160, for example, could be provided to extend away from the floor 115 of the housing 110 toward the lid 120 to aid in guiding wiring within the interior 114 of housing 110. Posts 160 can prevent binding or crimping of wires, for example, by providing a convenient structure for wires to be wound around. Posts 160 may also be useful in keeping wires away from a central portion of the interior 114 to provide additional space for terminations, wire nuts, etc. Posts 160 can be integrally formed during molding of housing 110, as illustrated. Equivalently, posts 160 could be added as separate components that are assembled into housing 110 in any manner. Posts 160 may be rectangular in shape, as shown, to permit convenient molding, or equivalently shaped to be round, oval, square, or any other cross-sectional shape desired. Posts 160 could be incorporated into any of the other junction boxes 100 described herein, if desired.

Junction box 100 may be affixed to a roof, wall or other mounting surface in any manner. In the example of FIGS. 1B-D, one or more fasteners 150 solidify the mount of junction box 100 against the mounting surface. Fasteners 150 could be implemented with galvanized screws, for example, that pass-through holes formed in the planar surface 115 of the housing 110, through holes in the mounting surface, and/or into any substrate or support structure existing below the mounting surface. If the roof or other surface is supported by a planar substrate (e.g., shingles, battens, decking, plywood or the like), fasteners 150 could extend into the substrate material for a more rigid connection. In roofs or other surfaces supported by wooden or composite battens, fasteners 150 could extend into the battens themselves. Other types of roofs may include other mounting or support structures and/or different types of fasteners, as desired. Sheet metal screws could be used, for example, or any sort of toggle or compression bolts, to provide just a few examples.

In the example of FIGS. 1B-D, mounting screws 150A-C are shown to pass through the floor 115 of housing 110 and into the mounting surface. Placement of mounting screws 150 can be guided by one or more bosses or holes that are integrally molded or otherwise formed in the floor 115 of housing 110 to indicate useful positions for the mounting screws 150. In some implementations, holes may be pre-drilled into floor 115 for convenience. In other embodiments, bosses 104 may be indicated with ridges, grooves, thinned regions and/or other marks in floor 115 without being pre-drilled, thereby assisting installers in drilling their own holes for the particular installation. This would permit some flexibility in deciding a number of fasteners 150 are desirable for a particular installation. That is, only the needed holes for any particular installation would be drilled in identified locations, thereby preventing unnecessary holes that could otherwise permit moisture leaks, condensation and/or the like. The locations of holes drilled and/or indicated in housing 110 may be sized in any manner and/or moved to any other locations on the planar surface 115 to permit any mounting scheme desired. Any number of mounting screws 150 could be used in any number of equivalent embodiments, and mounting screws 150 may be positioned in any manner. Additional details and other embodiments are described in more detail below.

In some embodiments, junction box 100 could include one or more drill grooves 108, 109 to indicated areas suitable for drilling in sidewalls 116. FIGS. 1A-D illustrate a drill groove 108 molded or otherwise formed on a side wall 116 in center position of the wall face extending vertically from a top of the housing 110 to a point approximately halfway between the top and bottom of housing 110. This drill groove 108 can be placed in a favorable location for drilling of holes that would permit conduit and/or wires to be connected to the box 100. Drill groove 108 may be placed in the center of the sidewall 116, for example, at a height that indicates clearance with components on the interior 114 of housing 110. Drill grooves 108 may be formed to be wide enough and/or otherwise appropriately sized to permit an installer to place a drill bit within the channel of the drill groove 108 and to start drilling while the drill bit is retained within in the drill groove 108. It is typical for roofing materials such as shingles and tiles to have different thicknesses, shapes and orientations so that the height of the needed drilling position can vary from embodiment to embodiment. Providing a drilling groove 108 rather than a single point therefore provides a more effective drilling guide that can adapt to different installations as needed because the installer can simply place the drill bit at any location along the drill groove to adjust for height of the tiles, shingles or other mounting conditions.

In some implementations, a single drill groove 108 may be provided on one or more sides of a junction box 100, but other embodiments include two or more drill grooves 108 on a side if desired. Some implementations could place guides on only certain walls (e.g., the east and west walls) but not on others (e.g., the north wall), if desired. Grooves 108 may be sized and spaced at any regular and/or irregular intervals, as desired.

Many of the figures shown herein also include side wall drill zone lines 109 in addition to drill grooves 108. Side drill zone lines 109 can be lines, grooves, marks or other indicia of areas of the sidewalls 116 that are (or are not) suitable for drilling. In the embodiment of FIGS. 1A-B, side drill lines 109 are appropriately placed to prevent the installer from drilling into the retention posts 106 and/or corners of the housing 110. Drill lines 109 could also demarcate areas that are blocked by other structures within the interior 114 of the box 100, as desired. Drill lines 109 may be simple marks that are thinner than the drill grooves 108, if desired, to differentiate the two markings and to prevent drilling into undesirable regions indicated by the lines 109. Drill lines 109 may therefore be differently-located in other embodiments. Still other embodiments may use drill zone lines 109 in place of drill grooves 108, or may eliminate drilling guides entirely if desired.

Injection molded junction boxes 100 may therefore be conveniently molded or otherwise formed with various integral features that can improve the connection of lid 120 to housing 110, the attachment of box 100 to a roof or other mounting surface, and/or the convenience of making electrical and/or fluid connections inside the box 100. These features may be individually or collectively incorporated into other junction boxes 100 described herein, as appropriate.

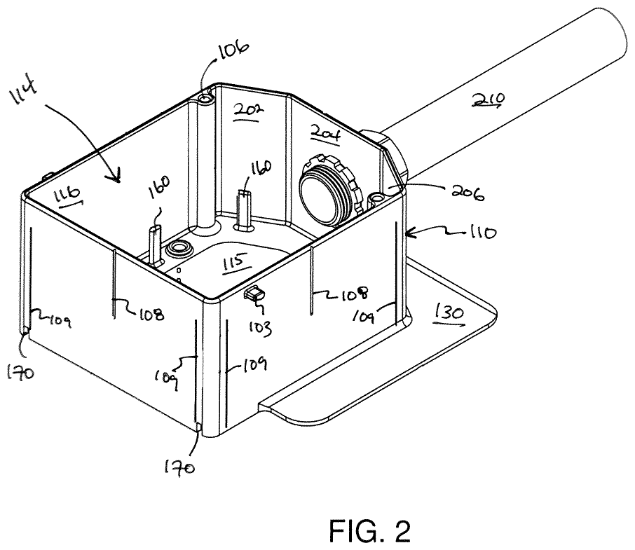

Turning now to FIG. 2, an example junction box 100 suitably includes a housing 110 (and matching lid 120, not shown) with a multi-sided shape having an angled “north” face 119 that points toward the apex of a sloped roof. In many cases, it will be beneficial to orient the junction box 100 on the roof so that the point 119 faces opposite the pull of gravity (e.g., toward the peak of a roof), thereby allowing water, debris and the like to be deflected away from the junction box 100. On the other hand, “pointed” sidewalls 116 can present spatial challenges in installing conduit or pipes. The example of FIG. 2 therefore provides a “north” facing sidewall 116 that includes three substantially linear sections 202, 204 and 206 that collectively provide a “point” to deflect water and debris, but that nevertheless provide a flat surface 204 that is orthogonal to the other sidewalls 116 that can be drilled to accept conduit 210 or the like. In this example, a hole of appropriate size to accept conduit 210 can be drilled into wall 204, and conduit can be secured using a threaded or other connector 212. Although wall 204 is smaller than other walls facing other directions, the adjacent sloping surfaces 202, 206 can greatly improve deflection of water and debris in comparison to a north face that is otherwise strictly linear. Other embodiments may be shaped in any other manner to include any number of walls 116, including any walls 116 that support junction boxes 100 that are round, polygonal, oval or any other desired shape.

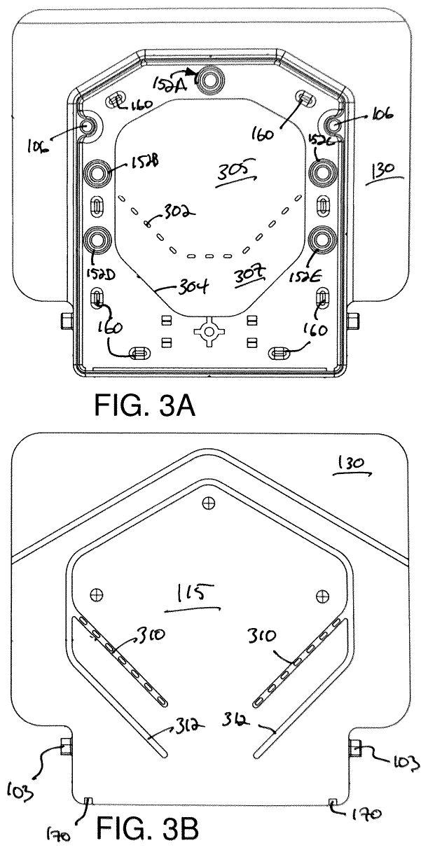

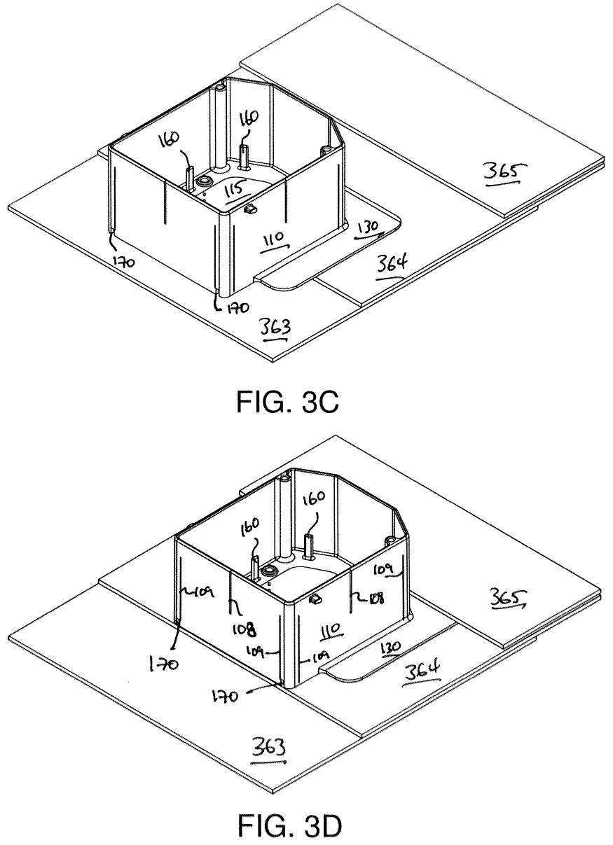

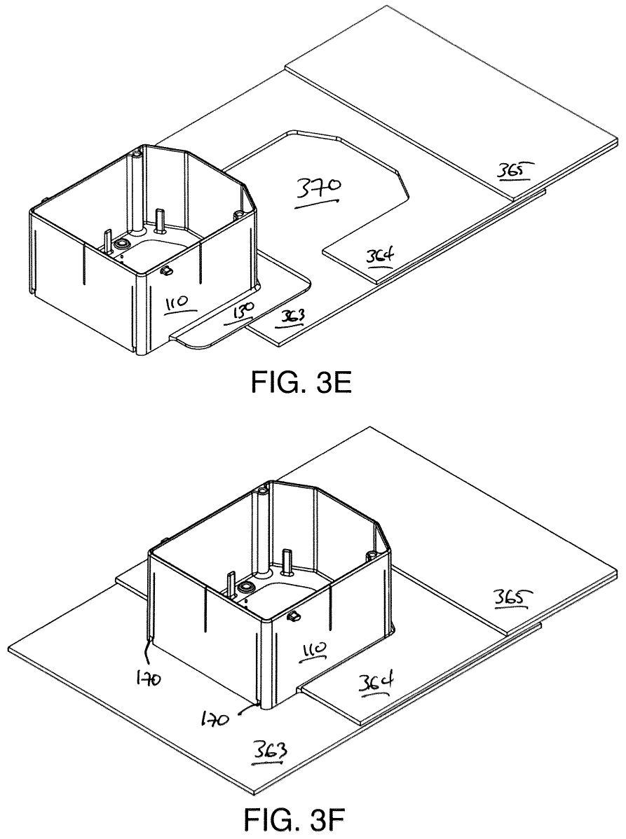

As noted above, some junction boxes 100 may include flashing 130 as appropriate for installation on tile roofs, shingle roofs and/or the like. FIGS. 3A and 3B show an example of a junction box 100 that includes flashing 130 that is molded or otherwise integrally formed with housing 110 and that is suitable for both micro flashing and full flashing, as appropriate. “Microflashing” in this instance refers to installation on a surface wherein there is no seam in the tile, shingle or other surface so that the flashing is secured to the surface using an adhesive or the like. Micro-flashing, as used herein, could also refer to a junction box 110 having a flashing 130 that is at least partially inserted under a single shingle or tile, as depicted in FIGS. 3C (prior to insertion) and 3D (after insertion). “Full flashing” or “standard flashing” refers to installations where a junction box is mounted under a seam between multiple tiles or shingles, usually after a suitable notch 370 has been cut to accommodate the junction box 100. Full flashing installation is illustrated in FIG. 3E (prior to insertion) and FIG. 3F (after insertion).

Both microflashing and full flashing installations can be accommodated in a single junction box 100 by providing multiple guides 302, 304 in housing 110 to delineate different drill zones (on the top surface of base 115) and different sealant positions (on the bottom surface of base 115) for different installations. FIG. 3A shows a top view of a junction box 100 in which two different drill zones 305, 307 are identified by two different lines 302, 304 to accommodate micro and full flashing (respectively). Lines 302, 304 may be grooves, ridges, raised or etched areas, and/or other lines that delineate respective drill zones 305, 307 that are appropriate for drilling in a particular installation. Lines 302, 304 may be integrally-formed in housing 110 through injection molding or the like.

In the example of FIGS. 3E-F, the full flashing of the junction box 100 is under two or more courses of shingles 363, 364, 365, which typically provides a more robust way of flashed installation that protects more of an area under the junction box 100 than where the junction box is micro-flashed on a single course of shingles or tiles. Thus, the drill zone 307 for a fully-flashed installation could include drill zone 305 that extends further to the downslope (“south”) portion of the box 100 than for micro-flashed installations. A junction box 100 using a micro-flashed technique would generally be better installed by focusing on the smaller area 305 above line 302 (which may correspond to the expected location of the single course of shingles or tiles) rather than creating additional holes in the downslope portion of the box 100 that could otherwise allow moisture or other contaminants to enter. Full-flashed installation on multiple shingle/tile courses, however, would not have these concerns due to the greater area of contact beneath box 100, so the installer could safely drill anywhere within the solid drill zone 307, including below the dashed line 302.

While FIG. 3 illustrates the micro-flashed drill zone line 302 as a dashed line and the fully-flashed drill zone 307 with a solid line 304, other drill zone markings are possible, such as colored zones, patterns within the drill zone, grooves or ridges marking the drill zone lines, etc. Other embodiments could delineate zones 305 and 307 using lines 302, 304 having different conventions than those illustrated (e.g., different types of dotted lines, lines of different thickness, etc.) if desired.

Similarly, microflashed and fully flashed implementations could demand different applications of sealant or adhesive on the bottom of the box 100, as indicated in FIG. 3B. In this example, the underside of flat surface 115 is molded or otherwise formed with grooves, ridges or other lines to indicate two different sealant guides 310 and 312 corresponding to micro and full flashing, respectively. This permits the installer to readily identify the appropriate position of sealant for the particular installation, as appropriate. That is, a microflashed installation will typically apply sealant along inner guide 310, whereas a fully flashed installation would typically apply sealant along outer guide 312. Guides 310, 312 may be grooves, ridges, lines or other markings that are molded into the bottom of housing 110. Guides 310, 312 will typically be sized and shaped to ensure that any holes drilled in the floor 115 of housing 110 lie inside the applied sealant for the particular installation. This will generally improve moisture resistance by keeping holes into the interior 114 of the box 100 inside the applied sealant. Many embodiments, however, will include a gap portion in the sealant guides 310, 312 rather than forming a complete circle (or oval, or other enclosed shape) around the drill zone of the box 100. This gap portion, generally in the downhill side of the guide 310, 312 can allow condensation or other moisture to escape from within the sealed area.

FIG. 3 also provides a clear view of bosses 152A-E to guide the application of fasteners 150 into the mounting surface. As noted above, some or all of the bosses 152 may be formed during molding to indicate where holes should be drilled, but without actually drilling the holes prior to installation. This would permit fasteners 150 to be placed in different positions for micro and full flashing, if desired, without creating holes that are not used in certain cases. In a micro flashed installation, for example it may be desirable for the installer to drill holes in bosses 152A-C without drilling bosses 152D and 152E, which could otherwise permit entry of moisture or other contaminants. Similarly, in a fully flashed installation, an installer may drill out bosses 152A, 152D and 152E to provide a broader region of compression without using additional fasteners 150, and without creating unnecessary holes in bosses 152B and 152C. Bosses 152A-E also provide a useful benefit in comparison to a simple hole because bosses 152 can provide thickened structure to prevent cracking during drilling and to accept additional compressive force than the rest of the box floor 115. While the embodiments of FIGS. 3A and 3B depict five total bosses 152A-E, other embodiments could equivalently use more or less than five bosses.

The features of housing 110 illustrated in FIG. 3 could be incorporated into any number of other embodiments, including any of the embodiments shown herein. By providing integral guides 302, 304 for drilling, as well as sealant guides 310, 312 and/or bosses 152 that are not-pre-drilled, a junction box 100 can be flexibly used in both micro-flashed and fully-flashed settings without reducing the water resistance provided in either setting.

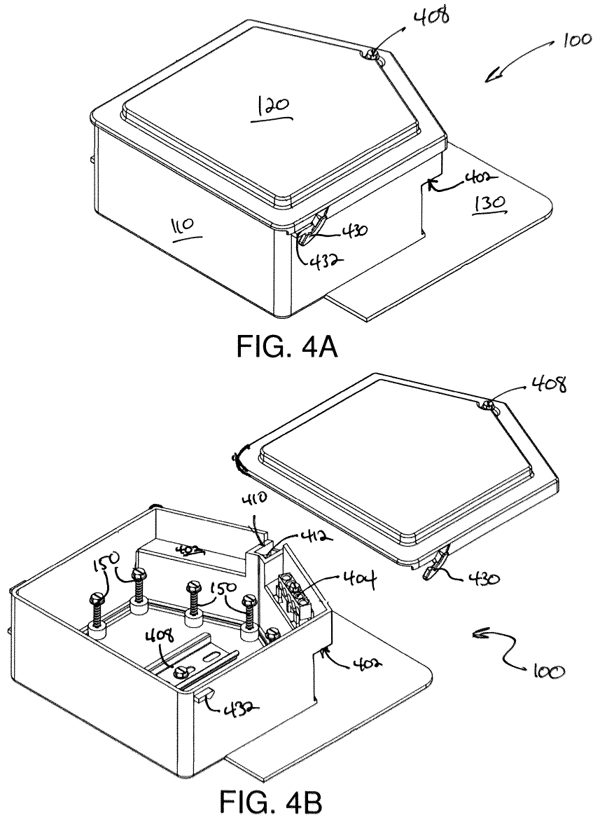

In some implementations, an overhang 402 can be useful in increasing the amount of useful space within the interior 114 of housing 110. FIGS. 4A-B show an example junction box 100 that is formed with an overhang 402 to provide additional space for mounting a ground bar 404, a boss for attaching the lid 120, and/or the like. In this example, the overhang 402 is oriented toward the “north” end of the box 140, although other embodiments could orient the overhang 402 in other directions, including the “south” direction described below. Embodiments with an overhang 402 on the side opposite the lid attachment structures 102/103 illustrated in the prior figures, however, would typically need a different design for attaching the lid due to the lack of space for receiving members 106 that would otherwise reinforce the northernmost corners of box 100. As an alternative, a slightly different tab 432 and retaining structure 430 that permits sliding of lid 120 and retention with a single fastener 408 could be provided, as shown in FIG. 4. In this example, retaining structure 430 is designed with an interior channel that permits tab 432 to be received within the retaining structure 430 in a manner that permits more rotation of lid 120 relative to housing 110. In practice, the more complex slide-in fastener may incur additional molding cost and complexity, but the overhang 402 does provide additional space for the ground bar 404 that would otherwise be present on the surface 115 of housing 110.

FIG. 4B also illustrates a snap-in DIN rail 408 that allows components to be mechanically attached within the interior portion 114 of housing 110. Generally speaking, a DIN rail is a metal rail that is of a standard type widely used for mounting electrical equipment. The term DIN comes from a specification originally published by Deutsches Institut für Normung (DIN) in Germany. In some embodiments, a DIN rail is mounted by inserting an end of the DIN rail 408 under a clip adjacent to a wall of the junction boxes and then securing the other end of the DIN rail using a clip, screw, or other fastener. (See FIG. 6 below.) Alternatively, DIN rail 408 may be mounted to the floor 115 of housing 110 with an adhesive, and/or with a screw or other fastener as appropriate. DIN rail 408 may be mounted within housing 110 in any position or orientation. Some embodiments may prefer to have the long axis of DIN rail 408 running in an east-west direction, for example, while other embodiments may prefer a north-south or other orientation within housing 110, as desired.

In some embodiments, the lid 120 is attached to the housing 110 using a screw, bolt or other attachment device 408 at the end of the box 100 opposite the tab 432 and retaining member 430 (e.g., the north end of FIG. 4). In some embodiments, a corresponding boss 410 in the housing 110 for the attachment device 408 is mounted outside of upper lip of the housing, as depicted in FIG. 4B. In this embodiment, the housing walls 116 include a notch 412 to accommodate the boss 410. Notch 412 is illustrated to traverse around the boss 410 to exclude moisture or other contaminants that may seep around the attachment device 408 from entering the junction box.

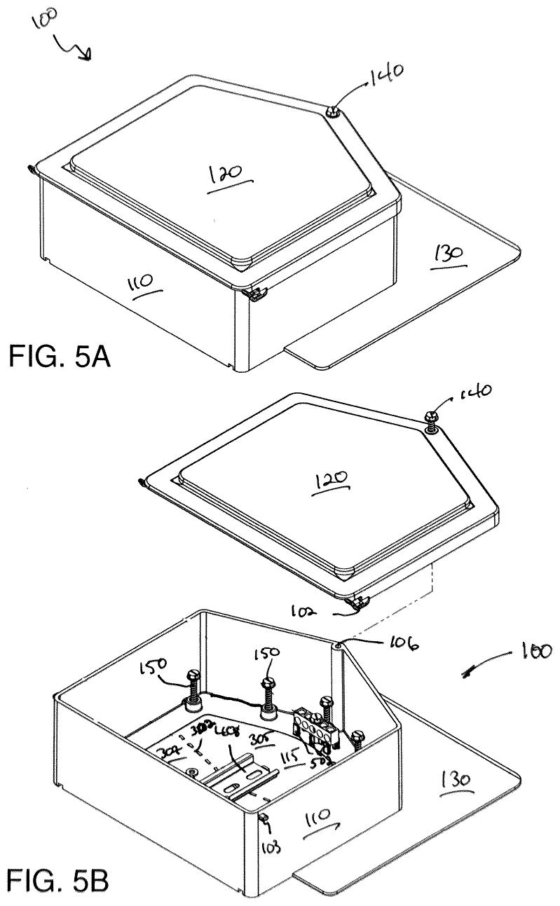

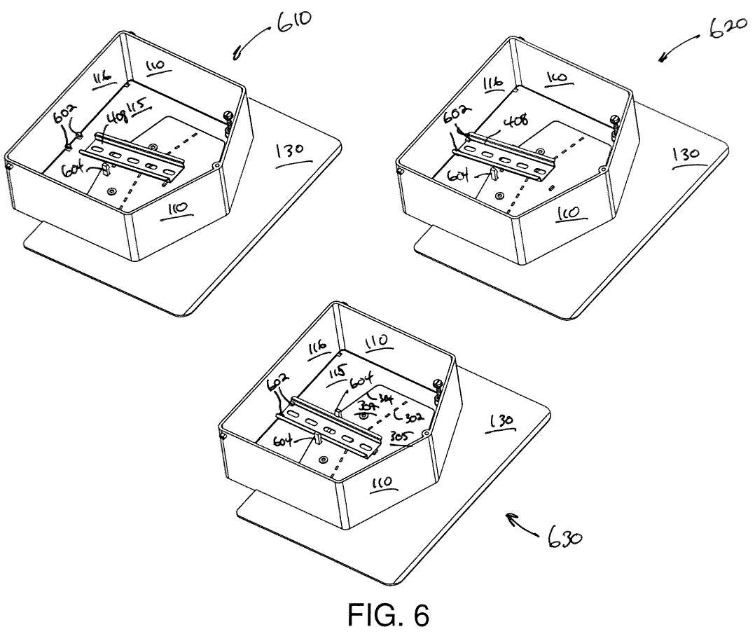

A similar junction box 100 that does not include an overhang 402 is illustrated in FIGS. 5A-B. In this example, the ground bar 404 is mounted to the floor 115 of housing 110 using one or more standoffs 502. In FIG. 5B, three standoff screws 502 are used, although other embodiments may use other numbers of standoffs 502 as desired, including a single raised post. Supporting the ground bar 404 above the floor 115 of housing 110 provides easier access to the bar 404, and also helps keep the bar 404 dry if moisture should somehow leak into the interior 114 of housing 110. DIN rail 408 is also provided, as appropriate. Although this implementation does not have the spatial advantages of the overhang 402, it is easier and less expensive to manufacture due to the less complex design. Also, the availability of receiving member 106 at the north end allows the simpler tab 103 and retaining structure 102 arrangement described in prior embodiments.

In various embodiments, housing 110 may be molded or otherwise formed to include end clips 602 and/or hook structures 604 to hold DIN rail 408 in place. Clips 602 and hook structures 604 may be integrally formed during injection molding of housing 110, as appropriate. FIG. 6 illustrates three different perspective views of junction boxes 100 having DIN rail 408. View 610 shows the DIN rail 408 placed within the interior 114 of housing 110. In view 612, an end of the DIN rail 408 is positioned under the clips 602 molded into the sidewall 116 of housing 110. View 614 shows DIN rail 408 snapped into hook structures 604 for retention within housing 110. Clips 602 are suitably formed to protrude from the sidewall 116 and/or the floor 115 of housing 110 at a height above the floor 115 corresponding to the height of DIN rail 408 to prevent vertical movement when the DIN rail 408 is in place. Similarly, hook structures 604 are positioned and placed to receive and to prevent lateral movement of DIN rail 408. Hook structures 604 may suitably include a hook that catches the DIN rail 408 when snapped into position, thereby rigidly retaining the DIN rail 408 in position. The particular shapes and positions of clips 602 and hook structures 604 may differ from embodiment to embodiment, as appropriate. Other embodiments could use any number of clips 602 and/or hook structures 604, as desired. FIGS. 5 and 6 as illustrated also includes guides 302, 304 for two separate drill zones 305, 307 as described above, although this is not required in all embodiments.

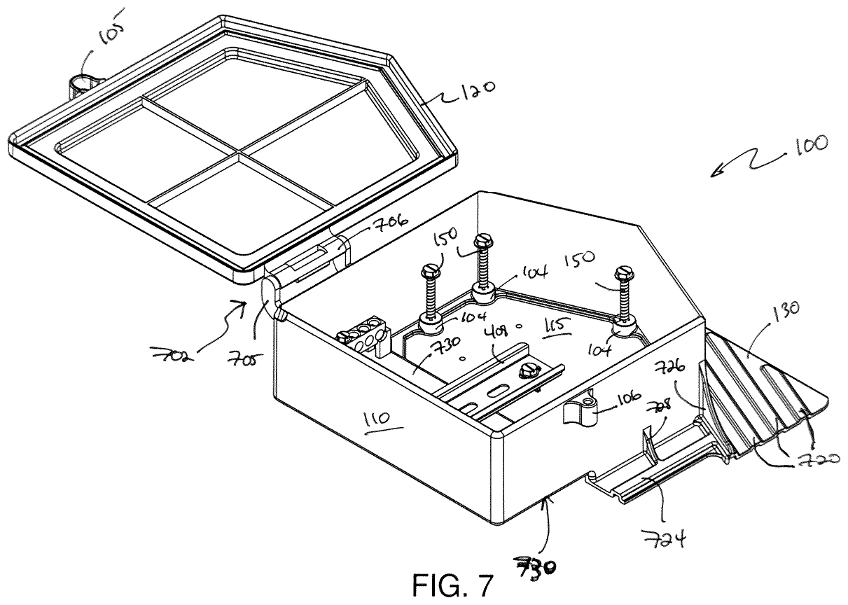

Another example junction box 100 having several different features is illustrated in FIG. 7. As shown therein, junction box 100 is molded or otherwise formed to include a hinge structure 702, as well as various water diverting features such as water-diverting ribs on a flashing. Hinge structure 702 appropriately includes two portions 705 and 706 integrally molded with housing 110 and lid 120, respectively, that are configured to snap together or otherwise mechanically cooperate to permit hinged movement of the lid 120 relative to housing 110. Lid 120 can be held in a closed position using a fastener 140 (not shown in FIG. 7) inserted through hole in lid 120 for retention within retention member 106 formed with housing 110, as desired. Other embodiments could provide a boss 104, such as bosses 104A-B shown in FIG. 1 to retain the fastener 140 in position prior to tightening.

In the example of FIG. 7, hinge 702 is located at the south end of the western sidewall 116 of box 100 to permit the use of a single-action mold during manufacturing. This benefit results from locating hinge 702 and retention member 106 to be “south” of flashing 130 to assist in the molding process. Other embodiments, however, could locate the hinge 702 in another position along sidewalls 116 as desired. Still other embodiments could use two or more hinges, if desired. Other lid closure and/or retention structures (including any of those described herein) could be used in other embodiments.

In some embodiments, it may be desirable to form the box housing 110 with a raised portion 730 so that the connected surface of the installed box 100 interfaces with only one shingle course. In the embodiment illustrated in FIG. 7, the raised portion 730 is downslope (“south”) of where attachment devices 150 or the like anchor the junction box 100 to the roof. In other embodiments, the raised portion 730 extends over a course of shingles or tiles that are below where the junction box 100 is mounted. In other embodiments, the raised portion 730 is downslope (“south”) of one or more sealant guides or sealant, as appropriate.

Raised portion 730 in this example also results in the downslope (“south”) end of the housing 110 being higher that the floor 115 towards the upslope (“north”) end of box 100. This raised portion 730 can help alleviate effects of ice build-up under the south end of the box from putting pressure on the fasteners 150 that secure the box 100 to a roof. Ice buildup could occur due to improper installation (e.g., lack of sealant and/or insufficient attachment devices 150), or from capillary action, wind, or the like. These effects can cause water to accumulate under the south end of junction boxes, which can then freeze. Over time, additional water may enter and cause a buildup of ice under the south end of box 100, which could otherwise undesirably loosen the connection of box 100 to the mounting surface.

Raised portion 730 is integrally molded with housing 110, and may be configured in any manner. In some embodiments, the raised portion 730 is located to be downslope (“south”) of where fasteners 150 anchor the junction box 100 to the roof. In other embodiments, raised portion 730 overhangs a course of shingles/tiles that are below where the junction boxes are mounted. In other embodiments, the raised portion 730 is located to be downslope (“south”) of one or more sealant guides or sealant, as described more fully below. Other embodiments could modify the raised portion 730 in any manner and/or could omit raised portion 730 entirely.

Although not expressly shown in FIG. 7, various embodiments could include one or more weep holes 170 at a south end of the raised portion 730 to allow liquid to drain out of interior area 114. In other embodiments, the bottom and/or sides 116 of the junction box 100 also have one or more weep holes 170 as described more fully above.

FIG. 7 also illustrates several features that can be useful in diverting water and/or debris away from the interior of junction box 100. Ridges in flashing 720, gussets 726 and 728, side ridges/sealant guide 724 are separately implementable features that may be found on different boxes 100, or that may be inter-combined as desired to prevent moisture, debris or the like from entering the interior 114 of box 100.

Gussets 726 and 728 can be formed on the exterior of housing 110 to provide increased structural support for loads created by fastener 140 toward the outer edge of box 100. Gussets can also aid in shedding water off of the side of box 100, as appropriate. Because shingles and tiles are not necessarily flat in practice, the extra downward force created by gussets 726 and 728 can help distribute downward force to make a firmer connection with the mounting surface. Although not visible in FIG. 7, the other side of box 100 (e.g., the west side) would typically include similar gussets 726, 728 to distribute force there as well.

FIG. 7 illustrates flashing 130 formed with one or more side ridges 724 along the lateral edges of box 100 to prevent fluids or other debris from approaching the side of box 100. Although not expressly shown in FIG. 7, embodiments that contain weep holes (described above) may benefit from a ridge 724 that protects against water entering interior 114 of box 110 via the weep holes 170. In some embodiments, side ridge 724 also serves as a capillary break for the bottom of flashing 130 to prevent capillary action from drawing water or other fluids into the interior 114 of box 100, as appropriate. Side ridges 720 may also serve as sealant guides for applying sealant to the bottom of box 100 during installation, if desired.

Flashing 130 as further illustrated in FIG. 7 includes water-diverting wings or ridges 720 that are oriented to divert water running along the north (upward) side of box 100 away from the sides of housing 110. Ridges 720 provide a path to divert water flowing down the slope of the roof or other mounting surface, and may also provide a capillary break to prevent water flowing between box 100 and the roof or other surface. That is, the raised ridges 720 can, if desired, form a gap that diverts water otherwise flowing between box 100 and the roof due to capillary action. Ridges 720 are generally molded or otherwise formed as raised portions of the flashing 130 that are angled outward from the center of the box so that any water flowing toward the north side of box 100 is diverted laterally away from housing 110. In various embodiments, raised ridges 720 are slightly tapered toward the center of box 100 to avoid lifting shingles or tile during installation, as described more fully below. Other embodiments may be formed in any other manner, as desired.

Although useful for diverting water away from box 100, ridges 720 on flashing 130 may increase the thickness of flashing 130 compared to embodiments without such ridges 720. The increased thickness could have the effect of raising shingle or tiles slightly, especially during micro-flashed installations, thereby increasing the chance of water flowing underneath flashing 130. To avoid this, the uppermost (“northernmost”) portion of flashing 130 may omit one or more ridges 720, as appropriate.

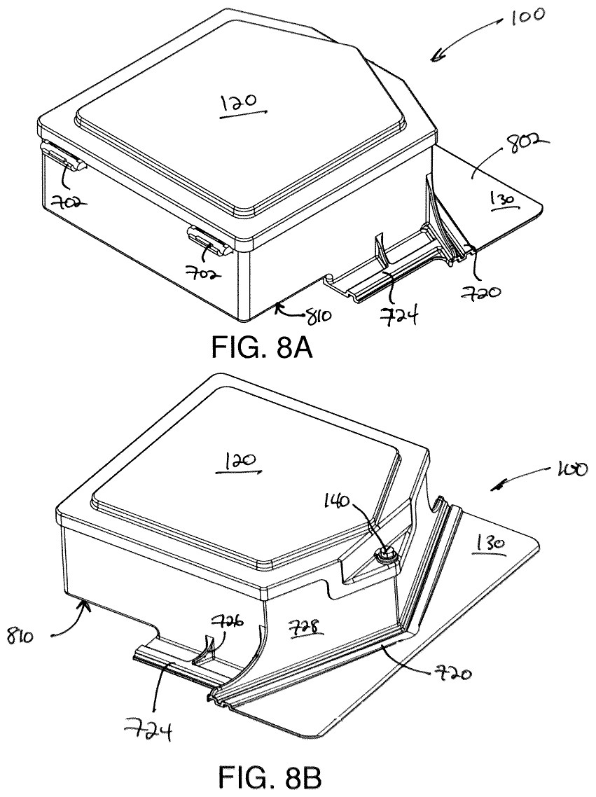

One example of a junction box 100 that omits the ridges 720 at the uppermost portion 802 of flashing 130 is illustrated in FIGS. 8A-B. This provides a flat surface at the upslope (northernmost) portion 802 of the flashing 130 that can more easily slide under a shingle or tile during installation. Additionally, a ridge 720 that is closest to the northern edge 802 of the flashing 130 can be tapered to be flat or nearly flat at an upper location that will be under a shingle/tile. The ridge 720 can then taper to have a full thickness at its downslope end, as appropriate, so that it is still effective in diverting water or debris. This tapering may be most useful in micro flashing installations where the flashing 130 is inserted under a lower edge of a single tile/shingle or under a lower edge of two adjacent shingles/ridges. In such embodiments, the shingle/tiles over the flashing 130 typically stop at or before a pointed northern side wall 116 of the junction box 100 so that the tapered portion of the ridge 720 lies under the shingles/tiles.

In some embodiments, flashing 130 is recommended to be limited to a thickness of about 0.08 inches or about 2 millimeters for the portion of the flashing 130 that slides under the shingle or tile for micro flashing installations. Often, injection molded parts have a minimum thickness of about 0.08 inches/2 mm or so. This means that forming the flashing ridges 720 could cause a total thickness of the portion of the flashing 130 with the flashing ridges 720 to be greater than a recommended thickness of 0.08 inches/2 mm if the ridges 720 are formed by simply thickening the flashing 130. To prevent this, the ridges 720 can be appropriately formed as channels in the bottom of flashing 130 so that the total thickness of the flashing material does not exceed thickness recommendations. These channels also help in diverting water flowing underneath box 100 due to capillary action, as mentioned above. Thus, the flashing design of FIGS. 8A-8B provides a way for micro flashing installations to meet thickness recommendations while still retaining some flashing ridges 130.

The example box 100 as illustrated in FIGS. 8A-B includes two separate hinges 702 formed on the south sides of the housing 110 and lid 120. The lid 120 therefore swings in a more vertical direction, which may be easier for installing components within the interior 114 of box 100. When closed, lid 120 can be held in position by fastener 140, which passes though lid 120 into a retaining member 106 as described above. FIG. 8 also illustrates a south-facing overhang 810 that can be useful in partially-flashed installations. Overhang 810 retains sufficient space in the interior 114 of housing 110 for connections, etc., but avoids contact with another course of shingles or tiles that could otherwise promote capillary action or other sources of contamination.

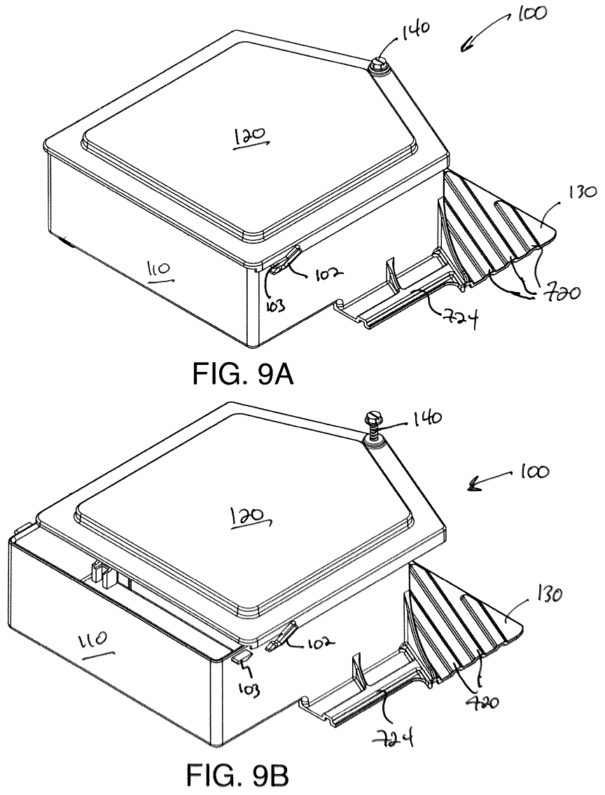

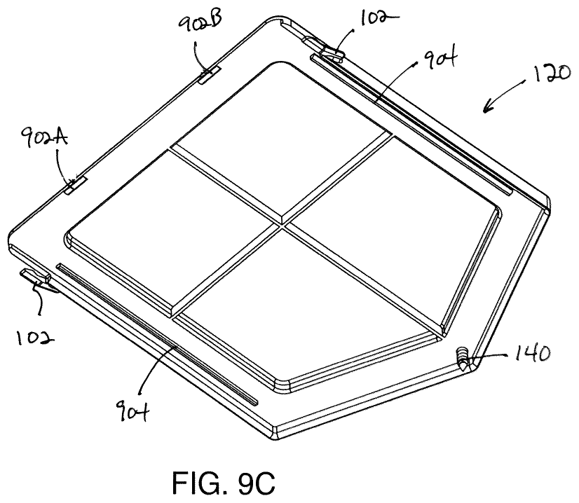

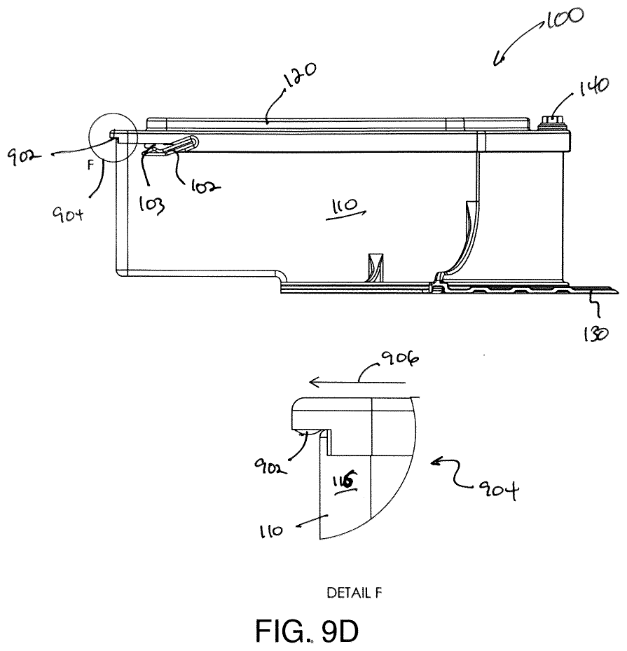

As noted above, the various features described herein may be inter-mixed and combined in any manner to create a large number of alternate but equivalent embodiments. The water repelling features of ridges 720 and/or 724, for example, could be incorporated into boxes 100 using any top of closure mechanism for attaching lid 120 to housing 110. FIGS. 9A-D, for example, show various views of a junction box 100 that includes a slidable top 120 that is formed with a joining member 102 that includes a snap-type structure that cooperates with tab 103 formed housing 110 when the top 120 is slid relative to housing 110. When lid 120 is slid along the top of housing 110 in a downslope (“southerly”) direction, the snap-type structure 103 deforms slightly when it first encounters tab 103, thereby permitting a hook or similar feature to “snap” into place when the lid 120 is correctly positioned. In various embodiments, top 120 may extend beyond the edge of housing 110 in the downslope (“south”) direction to permit one or more nubs 902A-B (FIG. 9C) to further retain the lid 120 in place relative to housing 110. FIG. 9D shows a side view of an example box 100 in which nubs 902, snap structure 102, tab 103 and a fastener 140 cooperate to maintain the lid 120 in fixed position relative to housing 110. The detail 904 of the downslope edge of lid 120 further shows how nubs 902A-B can extend past the south wall of housing 110 as the lid 120 moves in direction 906 relative to housing 110. FIG. 9C also shows two side rails 904 that can act as guides for placing lid 120 in sliding contact with housing 110. Although two nubs 902 and guides 904 are illustrated in FIG. 9, other embodiments could provide a single nub 902 or guilde 904, or any number of additional nubs 902 and/or guides 104 placed at any location along top 120 as desired.

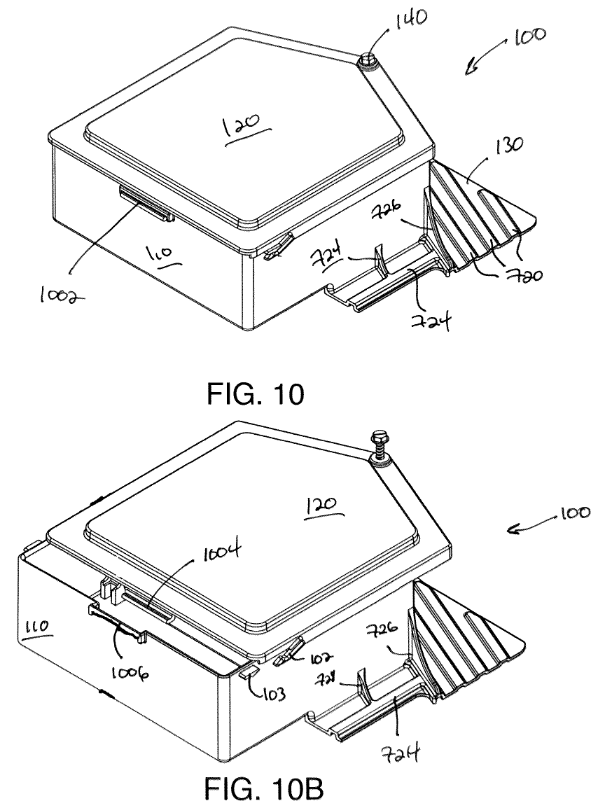

FIGS. 10A-B illustrate an example of a similar box 100 in which the nubs 902A-B are replaced by a hook-and-loop arrangement that is integrally formed on lid 120 and housing 110. In this example, lid 120 is formed with a rear hook 1004 that extends beyond the southern-most end of the lid to engage a loop structure 1006 that is formed with housing 110. As lid 120 is slid in the southerly direction from the position illustrated in FIG. 10A to the position illustrated in FIG. 10B, the rear hook 1004 of the lid 120 is pushed into cooperation with loop structure 1006 of the housing so that the lid 120 is retained in place. Although the example box illustrated in FIGS. 10A-B also includes side hook structures 103 and tab 102, these may not be necessary in all embodiments. One or more fasteners 140 may also be provided to further secure the lid 120 from the top as appropriate.

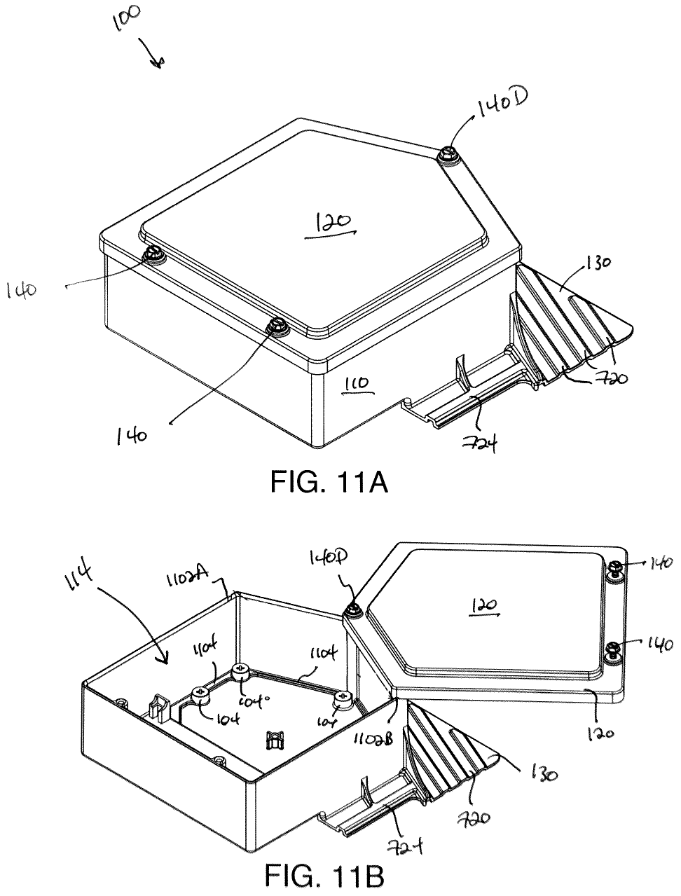

FIGS. 11A-B illustrate another example of a junction box 100 in which lid 120 can be rotated during installation or maintenance without removing the lid. In this example, fasteners 140 are provided at opposing ends of the box 100 (e.g., the north and south ends illustrated in FIG. 11), with one of the fasteners 140 (e.g., fastener 140D in FIG. 11) acting as a pivot point for rotating the lid 120 relative to the housing 110. That is, fastener 140D can be loosened while the other fasteners 140 are removed so that the lid 120 is free to rotate relative to housing 120 (FIG. 11B). If desired, one or more notches 1102A-B can be formed in the upper sidewall 116 of housing 110 to receive the edge of lid 120 and thereby prevent movement of lid 120 during installation of maintenance of components located in the interior 114 of housing 110. If desired, notches 1102 may be alternately formed in the lid 120 to mate with the edge of sidewall 116 of housing 110, or notches 1102 could be formed in both sidewall 116 and in lid 120, if desired. Other embodiments could provide different structures to permit rotation of lid 120 and/or to maintain lid 120 in a displaced position relative to housing 110, as desired. If the perimeter of lid 120 includes a U-shaped channel, for example, then two notches 1102 could be placed in each top edge of the junction box (a total of four notches 1102) so that both ridges of the U-shaped channel are received in notches at both points where the lid 120 meets the housing 110. In some embodiments, the notches 1102 are sufficiently deep to hold the lid 102 but are less than a depth that an outer edge of the lid 120 covers the upper edge of housing 110 so that the lid 120 covers the notches 1102 when the lid 120 is in the closed position (FIG. 11A). Although FIG. 11B shows two notches 1102A-B to facilitate placing the lid 120 into two different positions, other embodiments could provide a single notch, or could provide additional notches as desired to accommodate any number of fixed positions for rotating lid 120.

In the illustrated embodiment, lid 120 is secured by three fasteners 140, with one fastener 140D being positioned at a northern tip of the lid 120. When the two fasteners 140 along the southern edge of the lid 120 are up and out of their retaining bosses 104 in the housing 110 and the north fastener 140D is partially inserted into a boss 104 or other retaining member 106 on the northern portion of housing 110, lid 120 can be rotated around the north attachment device 140D and into one or more notches 1102. In some embodiments, the fasteners 140 are captive in the lid 120 so that they do not accidentally fall away and become lost. In some embodiments, the north fastener 140D is semi-captive in its boss 104 so that it is difficult to remove completely without significant force. Other embodiments could be organized in any other manner.

FIG. 11B also illustrates an example of a compression ring 1104 that could be used in any of the embodiments described herein. In various embodiments, compression ring 1104 is a thickened ring located along edges of the interior portion 114, such as at the interface of bottom surface 115 and sidewalls 116. Ring 1104 is appropriately formed to be contiguous with or at least adjoin bosses 104 for fasteners 150. In some embodiments, one or more compression rings 104 are formed to be thicker than other portions of the bottom surface 115 of housing 110. In operation, bosses 104 tie into the compression ring 1104 to transfer force from fasteners 150 to the compression ring 1104 as the fasteners 150 are tightened. The compression ring 1104 serves to stiffen the areas along the ring 1104, thereby providing additional compressive force to a sealant applied to the underside of box 100. To that end, it may be desirable to design the relative locations of bosses 104 and compression ring 1104 to correspond with any channels or guides provided on the underside of junction box 100. Other embodiments may position rings 1104 in any other manner, as desired. Although not specifically discussed above, FIGS. 4B and 7 also illustrate compression rings 1104; similar structures could be incorporated into any other embodiments as desired.

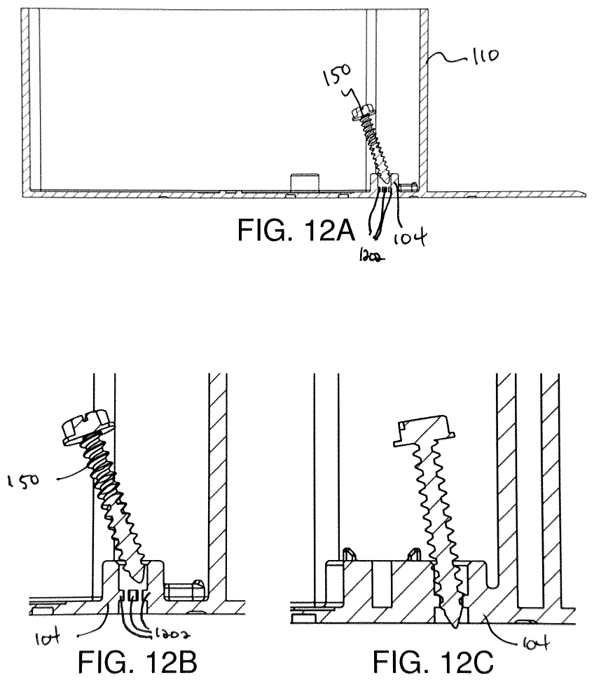

Some junction boxes 100 could provide bosses 104 that capture and maintain fasteners 140 and/or 150 to aid in installation and to prevent the fasteners 140/150 from becoming lost. FIG. 12A, for example, illustrates a side cross section view of a junction box 100 with a boss 104 that receives a conventional fastener 140/150 as it begins to be inserted into boss 104. In the enlarged cross section of FIG. 12B, all of the teeth 1202 in the conventional boss 104 are in line with each other, which makes it possible for the fastener 140/150 to enter the boss 104 at an angle, thereby cutting threads in a crooked orientation. FIG. 12C is an enlarged side cross section view with the fastener 140/150 further advanced, noting that the crooked orientation is maintained because the fastener 140/150 has cut threads into the boss 104 that maintains the tilted angle.

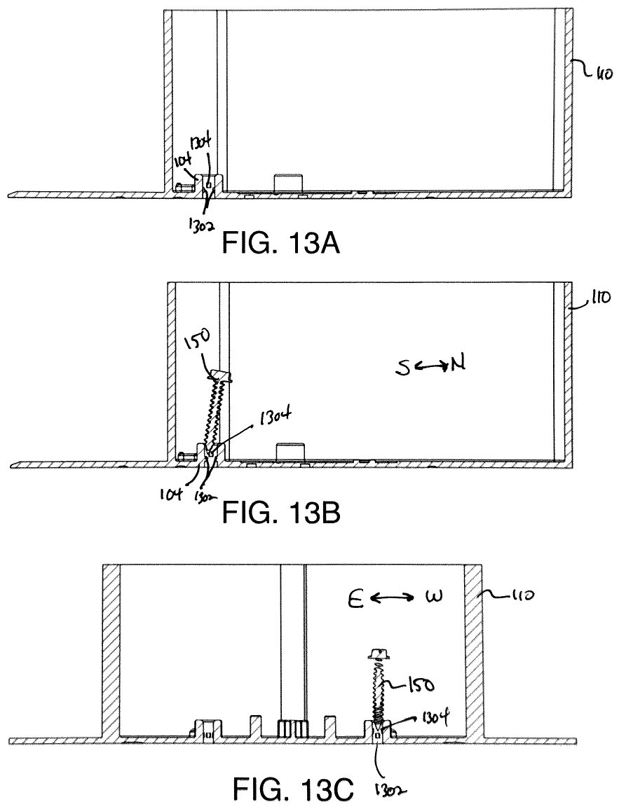

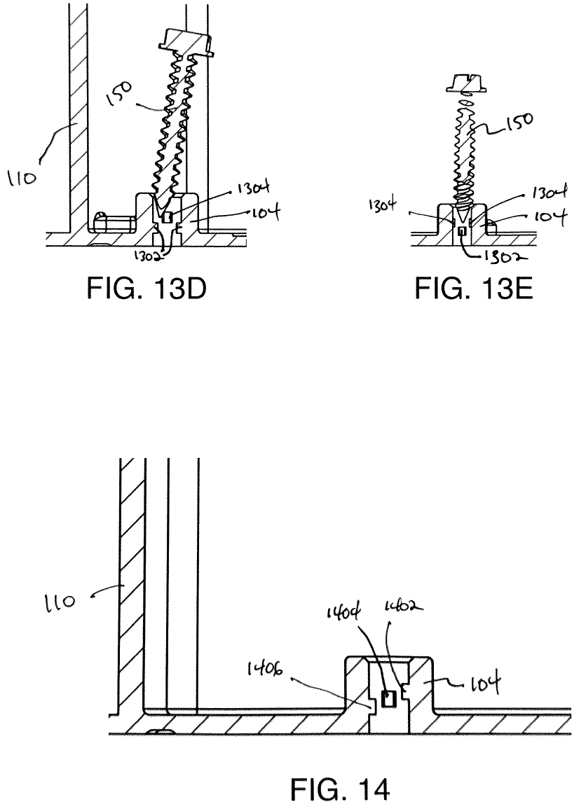

FIG. 13A, in contrast, illustrates a junction box 100 in which boss 104 is formed with sets of self-aligning captive teeth 1302, 1304 prior to a fastener 140/150 being inserted into the boss 104. The self-aligning captive screw design includes sets of teeth 1302, 1304 that are offset, which helps to align the fastener 140/150 being inserted. In the embodiments of FIG. 13A, north and south teeth 1302 are in line with each other while east and west teeth 1304 are aligned with each other but offset higher up the boss 104. FIG. 13B is a side cross section view of the junction box of FIG. 13A with a fastener 150 starting to be inserted. FIG. 13C is an end cross section view of the junction box of FIG. 13A in a direction orthogonal to the offset view of FIG. 13B. FIG. 13D is an enlarged cross section view of FIG. 13B, and FIG. 13E is an enlarged cross section view of FIG. 13C. As shown in each of the FIGS. 13A-E self-aligning screw teeth 1304 helps to hold the fastener 150 in alignment in the east-west direction, as depicted in FIGS. 13C and 13E, while the fastener 150 is tilted in the north-south direction, as depicted in FIGS. 13B and 13D. As the fastener 150 is then inserted further into the boss 104, the lower north-south teeth 1302 force the fastener 150 into alignment in the north-south direction so that the fastener 150 is upright before exiting the boss 104. In other embodiments, the teeth 1302, 1304 are offset at any other distance. Still other embodiments could rotate the teeth 1302, 1304 with respect to the boss 104, if desired. In still other embodiments, additional teeth 1302, 1304 are added above and/or below the lower set of teeth 1302, as appropriate.

FIG. 14 is a side cross section view of a junction box 100 with a boss 104 having spiraled self-aligning captive screw teeth prior to a fastener 150 being inserted, according to various embodiments. As a fastener 150 is inserted into the boss 104, the first tooth 1402 nearest the top engages the fastener 150 and forces the fastener 150 in a particular orientation. As the fastener 150 is inserted further and encounters a second next lower tooth 1404, this second tooth then exerts a force on the fastener 150, further aligning the fastener 150 in another direction. As the fastener 150 is inserted still further and encounters the third and next lower tooth 1406, this third tooth also exerts an aligning force. As the fastener 150 is inserted further, a fourth and next lower tooth (not shown) exerts a force in a fourth direction. After encountering the teeth 1402, 1404, 1406 and/or any additional teeth, fastener 150 is typically maintained to be upright and ready to be screwed straight through the boss 104 into the mounting surface or other underlying substrate. The spiraled teeth could be equivalently configured to spiral in an opposite direction to that illustrated in FIG. 14. In other embodiments, the spiraled captive screw design includes additional or fewer teeth, such as three teeth or more than four teeth. Other similar screw capture designs could be equivalently formulated with the teeth being spaced to align fastener 150 entering boss 104.

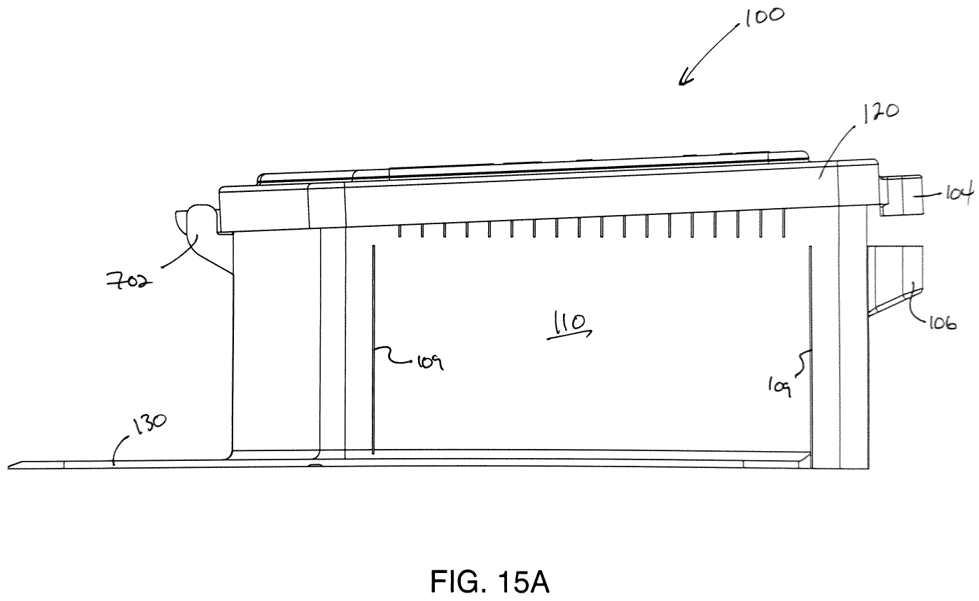

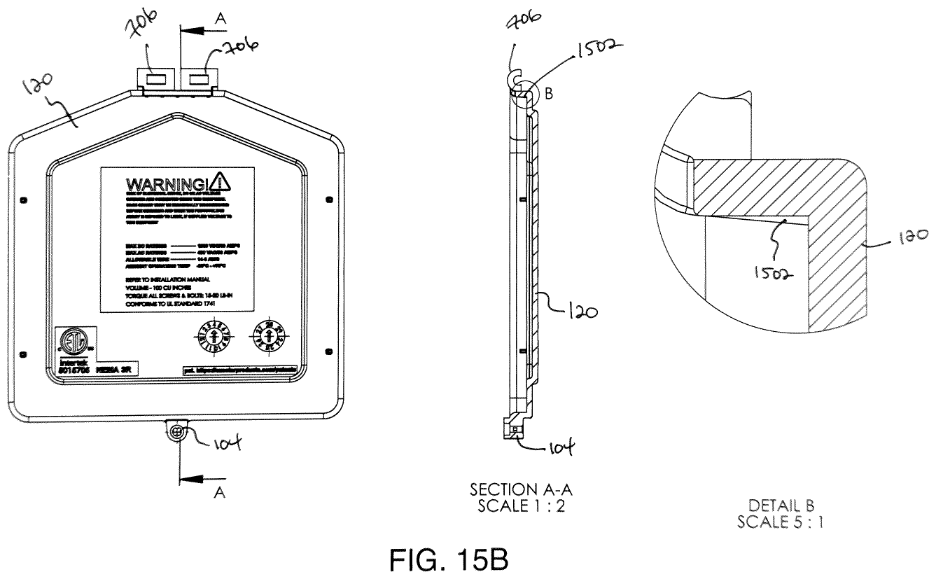

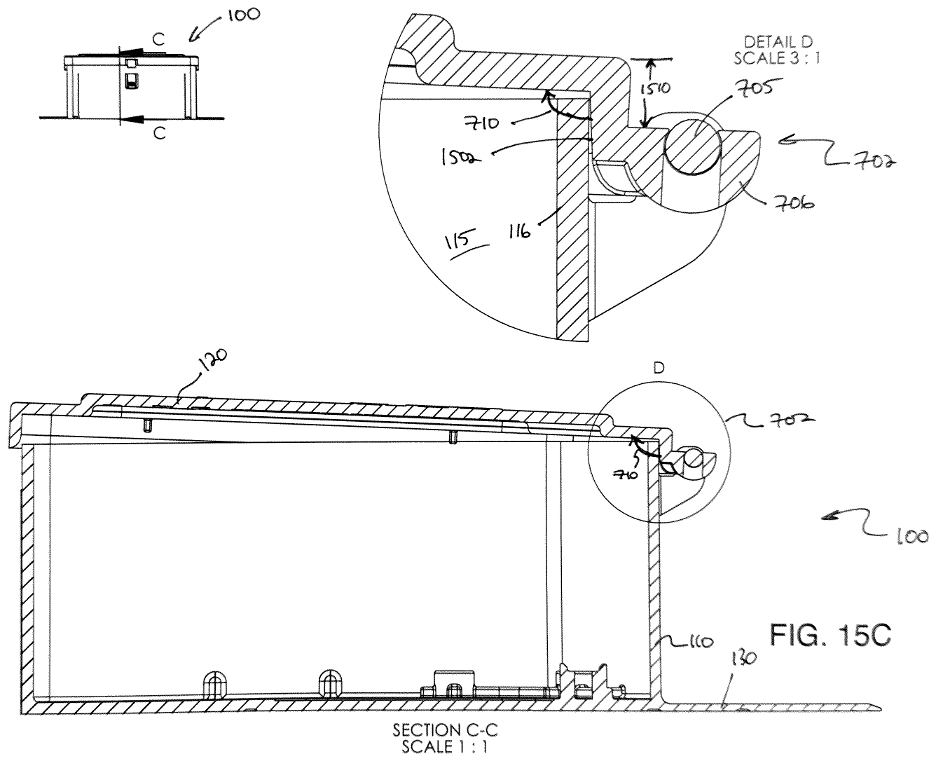

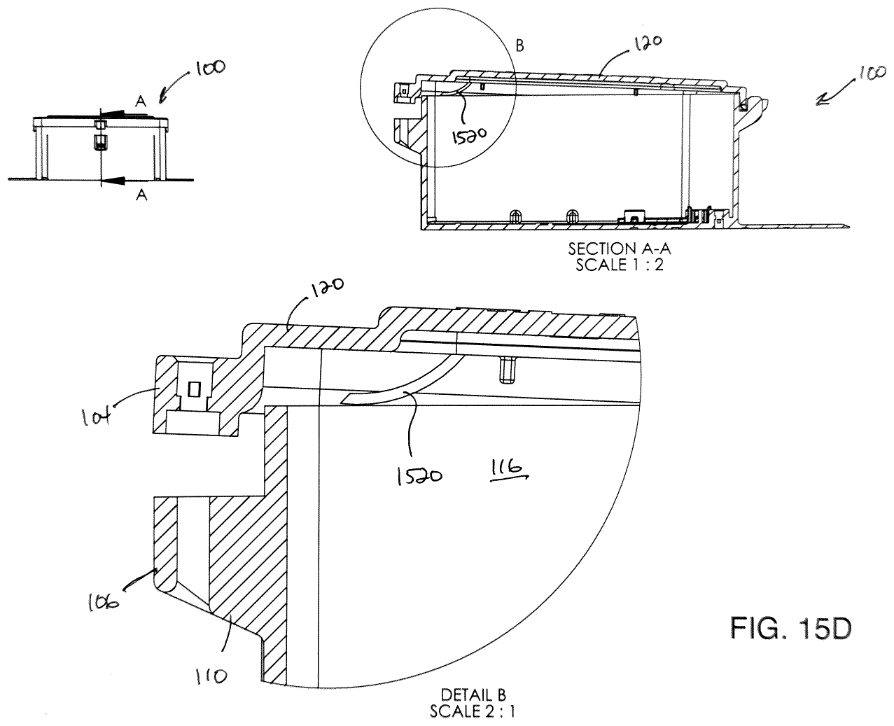

FIGS. 15A-D illustrate another example embodiment that incorporates several of the features described above including a hinged lid 120 and weep holes 170. In this example, lid 120 is slightly biased toward an open position away from housing 110 by structural features integrally formed with the lid 120 and/or housing 110. As shows in FIG. 15A, junction box 100 suitably includes a housing 110 with flashing 130 and drill indicators 109 that cooperates with a lid 120 having one or more hinges 702, as appropriate. In this particular example, two hinges 702 are located on an upslope (“northern”) edge of the box 100, although other embodiments could provide different types of closure arrangements, including different numbers of hinges 702 located in any position, using hinges 702 of different sizes (e.g., one large hinge 702 instead of two smaller hinges 702), and/or the like. Box 100 is maintained in a closed position using a fastener 140 as described above that passes through a boss 104 and into a retaining member 106, again as described above.

Lid 120 is biased toward the open position in any manner. In some implementations, lid 120 includes one or more spring members, ribs or other protrusions 1502 to place lid 120 into the desired open position until pressure is applied by a fastener 140 or the like. Protrusions 1502 place a slight upward pressure on the lid 120 that is readily overcome when the lid 120 is fastened shut on housing 110, but that otherwise opens the lid 120 slightly when the fastener is released. This slight pressure can be desirable to assist in opening the lid 120, and to provide better visual indication when the lid 120 is opened. By placing a slight bias on the lid 120, then, it will usually be more obvious when the lid 120 is not closed, thereby potentially reducing the potential for the lid 120 to be left open unintentionally. The protrusions 1502 are typically molded features that are integral to the lid 120, although one or more protrusions 1502 could be equivalently molded (or otherwise integrally formed) in the wall of the housing 110, if desired. In other embodiments, a separate tab or other member formed of plastic, metal, composite and/or any other material could be inserted between the lid 120 and housing 110 to perform the same biasing function of interference 245, as desired.

In the example of FIG. 15B, protrusions 1502 are implemented using relatively thin ribs that are present on lid 120 and that rub against the housing 110 until deformed by applied pressure. These ribs 1502 may be present, for example, within a corner of the lid 120 located near the hinge 702. Pressure applied by a fastener 140 on the opposite side of lid 120 will have enough leverage in this arrangement to readily deform the thin ribs 1502 when desired. Any number of ribs 1502 may be present on lid 120, with the thickness and sizing of the ribs 1502 being determined by the amount of applied force that is desired to overcome the bias of lid 120.

FIG. 15C shows that the bias can also be adjusted based upon the angle 710 of the top 120. This angle 710 may be created by protrusions 1502 and/or by designing the molded top 120 to exhibit a desired angle 710 as desired. In the example illustrated in FIGS. 15A-D, lid 120 includes a bit of sidewall portion that elevates that top portion of the lid 120 above the hinge portion(s) 706. This elevated structure also provides improved sealing of the lid 120 to the housing 110, thereby improving resistance to moisture and other contaminants. Protrusions 1502 are typically present on inner side of the vertical portion of the lid 120 to interface with sidewalls 160 of housing 110. Adjusting the angle 710 between the vertical and horizontal portions of the lid 120 through sizing of the protrusions 1502 and/or the structure of the lid 120 can therefore affect the bias of the lid 120 in a desired manner. A larger angle 710, for example, will typically open the lid 120 to a greater distance, and/or will require a greater applied force to overcome the bias. Conversely, a smaller angle 170 will reduce the amount of bias and/or the amount of force that would be applied to overcome the bias. Other embodiments may be designed to incorporate these or other biasing features as desired.

The bias can also be adjusted though tuning of hinge 702. That is, adjusting the location and interfit of hinge components 705, 706 can affect the amount of bias and/or the amount of pressure needed to overcome the bias as desired. One way to adjust the hinge 702 is to place the hinge 702 at a higher or lower position relative to the top of the lid 120. That is, by adjusting distance 1510 in FIG. 15C. The illustrated example includes a lid 120 that features both a horizontal portion for covering the internal portion 114 of box 100, as well as a vertical position that forms a firm seal between lid 120 to housing 110. The vertical portion may form a lip, for example, that overhangs the edges of the sidewalls 116, thereby helping to shed water. Again, adjusting the vertical distance from the top of lid 120 to the hinge 702 can serve to place additional biasing force on lid 120, as desired.

FIG. 15D shows an additional and/or alternate technique for creating a bias in the position of lid 120. As illustrated therein, a spring member 1520 is provided as a protrusion or biasing member that places an upward force on lid 120. As pressure is applied to lid 120, the spring member 1520 is compressed, thereby allowing lid 120 to close again housing 110. Spring member 1520 may be an integrally-formed feature of lid 120 and/or housing 110 in some implementations. In other embodiments, a separate spring member made of metal, plastic, composite and/or other material may be placed between lid 120 and housing 110 to provide a bias against the lid 120, as desired.

As noted at the outset, the various concepts described herein may be mixed and matched as desired to create any number of alternate but equivalent embodiments. A junction box could be created with or without flashing, for example, that incorporates multiple drill zone indicators, moisture diverting features and/or weep holes. Any of such boxes could be formed with lids that attach via traditional fasteners, hinges, attachment features that support sliding and/or pivoting, and/or the like. The examples presented herein are frequently described with reference to a junction box that is mounted to a tile or composite shingle roof; equivalent embodiments, however, could mount the box to any other mounting surface as desired, including walls or other exterior surfaces of homes or other structures. A practical implementation of a junction box as described herein will typically exhibit at least some variations in size, shape, locations of components, and/or any number of other factors from the illustrated examples.

Although some of these variations have been expressly described herein, other variations could be formulated across a wide variety of equivalent embodiments. To provide one example, many of the junction boxes 100 are described with regard to electrical wiring, often in connection with rooftop solar installations. Equivalent embodiments, however, could be used to support piping of water or other fluids. One way to facilitate fluid flow applications would be to allow one pipe to enter a side (e.g., “east” or “west” face) of the box 100 with another pipe being connected to another face, such as the downward (“south”) face to facilitate gravitational fluid flow. In addition to providing a junction for two pipes, box 100 could provide an additional benefit of providing a convenient 90-degree turn device, such as an “LB,” elbow, or the like without the need for a “roof boot”. Typically, a roof boot is a type of flashing with a cone-shaped extension having a hole at the top that is commonly placed around conduit, piping, air ducts, or other roof penetrations to direct liquids away from the roof penetration. Some roof boots include a top portion made of rubber or other pliable material that is designed to fit tightly around a conduit, pipe, roof vent, etc. Frequently, fluid flow applications are designed so that conduit, piping, etc. extends horizontally on roof for a distance and then penetrates into the roof, often at a right angle (or near right angle). In such settings, conduit, piping, etc. penetrating the roof is covered with a roof boot before entering an opening of an LB or elbow. Another horizontally mounted conduit, pipe, etc. then enters another side of the LB or elbow. Again, any of the junction box embodiments described herein could be readily modified to support fluid flow applications.

The junction boxes described herein could be equivalently used to eliminate the need for a roof boot or 90-degree turn device. In one example, conduit, piping, etc. could enter a side of the junction box that is mounted to a roof with sealant to provide fluid or electrical connectivity though a roof penetration for a conduit, piping, etc. that would prevent moisture or other contaminants from reaching the roof penetration. In some embodiments, the junction box includes piping entering a side of the junction box, a pipe extending through the roof and a liquid-tight lid that prevents fluid in the junction box from escaping the junction box. In other embodiments, conduit enters the side and bottom of the junction box so that wiring can pass through the junction box, thereby allowing the junction box to serve as a pull box. Terminating can be provided as desired in the junction box to thereby eliminate a roof boot and/or LB. Again, a wide variety of equivalent embodiments could be created across a variety of implementations and settings in addition to those expressly set forth herein.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

While several example embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A junction box for attaching to a mounting surface, the junction box comprising:
a housing formed of molded composite material and having a planar surface and a wall structure extending substantially perpendicularly from the planar surface away from the mounting surface to enclose an interior region of the junction box, wherein the housing further comprises a first joining member integrally formed with the wall structure of the housing; and
a lid formed of the molded composite material, wherein the lid is shaped and sized to mate with the wall structure of the housing, the lid comprising an integrally-formed second joining member configured to interface with the first joining member of the housing to thereby maintain the housing and lid in rigid proximity to each other and thereby fully enclose the interior region of the junction box.

2. The junction box of claim 1 wherein the first joining member comprises a tab integrally molded with an exterior surface of the wall structure and wherein the second joining member comprises a loop structure integrally molded to project from an outer surface of the lid, wherein the loop structure is configured to receive the tab of the wall structure and thereby maintain the housing and lid in rigid proximity to each other.

3. The junction box of claim 1 further comprising one or more wire management posts integrally molded with the housing, wherein the one or more wire management posts project upward from the planar surface of the housing into the interior region of the junction box.

4. The junction box of claim 1 further comprising at least one boss integrally molded in the planar surface of the housing to guide placement of a fastener connecting the junction box to the mounting surface, wherein at least one boss does not extend completely though the planar surface to form a hole therein.

5. The junction box of claim 4 wherein the at least one boss comprises first and second sets of teeth for receiving threads of the fastener, wherein the first set of teeth is oriented to above the second set of the teeth in a recessed area of the boss, and wherein the first and second sets of teeth are oriented orthogonally from each other within the recessed area of the boss.

6. The junction box of claim 1 further comprising one or more clips integrally molded into a sidewall of the housing and one or more hook structures integrally molded in the planar surface of the housing, wherein the one or more clips and the one or more hook structures are configured to retain a DIN bar in place within the interior region of the junction box.

7. The junction box of claim 1 wherein the housing is integrally molded with a flashing that comprises one or more raised ridges angled to divert water away from the housing.

8. The junction box of claim 7 wherein at least one of the one or more raised ridges is tapered toward a center of the junction box.

9. The junction box of claim 8 wherein the one or more raised ridges is set back from an upslope edge of the flashing to thereby permit at least a portion of the flashing upslope from the one or more raised ridges to be slid beneath a portion of the mounting surface.

10. The junction box of claim 1 wherein the housing comprises first and second integrally-formed lines in the planar surface, wherein the first integrally-formed line indicates a first drill zone for use during micro-flashed installations of the junction box, and wherein the second integrally-formed line indicates a second drill zone that is larger than the first drill zone for use during fully-flashed installations of the junction box.

11. The junction box of claim 10 wherein the housing further comprises a plurality of bosses integrally formed in the planar surface, wherein each of the plurality of bosses is configured to receive a fastener that passes through the planar surface into the mounting surface, but wherein each of the plurality of bosses extends only partially through the planar surface to thereby permit use of a first plurality of bosses during the micro-flashed installation and a second plurality of bosses different from the first plurality during fully-flashed installation.

12. The junction box of claim 1 wherein the planar surface of the junction box is formed with one or more bosses each configured to receive a fastener for attaching the junction box to the mounting surface, and wherein the planar surface is formed with a compression ring interconnecting the one or more bosses to thereby apply additional compressive force against the mounting surface when the faster is tightened into the mounting surface.

13. The junction box of claim 12 wherein the compression ring is located on the planar surface in a position that corresponds to a guide on an opposite side of the planar surface that indicates a position to apply an adhesive for further connecting the junction box to the mounting surface.

14. The junction box of claim 1 wherein the lid is integrally formed with one or more protrusions on an inner surface of the lid, wherein the protrusions are configured to interface with the wall structure of the housing and thereby bias the lid into an open position until closing pressure is applied to the lid.

15. The junction box of claim 14 wherein the lid comprises a vertical portion and a horizontal portion overlying the housing, and wherein the protrusions are formed at an intersection of the vertical and horizontal portions of the lid to thereby affect an angle between the vertical and horizontal portions.

16. The junction box of claim 14 wherein the one or more protrusions comprise a spring member that applies a force against the housing that is overcome through tightening of a fastener that joins the lid to the housing.

17. A junction box for attaching to a mounting surface, the junction box comprising:
a housing formed of molded composite material and having a planar surface and a wall structure extending substantially perpendicularly from the planar surface away from the mounting surface;
a lid formed of the molded composite material, wherein the lid is shaped and sized to mate with the wall structure of the housing to enclose an interior region of the junction box; and
a flashing integrally formed of the molded composite material with the housing, wherein the flashing comprises at least one ridge molded into the flashing that is oriented away from a center of the junction box to thereby divert water flowing toward the junction box toward an edge of the flashing.

18. The junction box of claim 17 wherein the housing comprises first and second integrally-formed lines in the planar surface, wherein the first integrally-formed line indicates a first drill zone for use during micro-flashed installations of the junction box, and wherein the second integrally-formed line indicates a second drill zone that is larger than the first drill zone for use during fully-flashed installations of the junction box.

19. The junction box of claim 18 wherein the housing comprises one or more weep holes in the wall structure extending above the planar surface to thereby drain moisture from the interior region of the junction box.

20. The junction box of claim 19 wherein the flashing further comprises a side ridge proximate an exterior side of the housing, wherein the side ridge is a raised portion of the flashing configured to divert water flowing toward the junction box.
